(19) United States
(12) Patent Application Publication
(10) Pub. No.: US 2018/0051231 A1
(43) Pub. Date: Feb. 22, 2018

(54) IMPROVEMENTS IN OR RELATING TO ORGANIC COMPOUNDS

(71) Applicant: GIVAUDAN SA, Vernier (CH)

(72) Inventors: Ioannis KONTARIS, Kennington, Kent (GB); Jeremy Nicholas NESS, Ashford Kent (GB); Jennifer SUMMERFIELD, Cheltenham (GB); Chi ZHANG, Shanghai (CN)

(73) Assignee: GIVAUDAN SA, Vemier (CH)

(21) Appl. No.: 15/555,165

(22) PCT Filed: Mar. 16, 2016
(86) PCT No.: PCT/EP2016/055665

§ 371 Date: Sep. 1, 2017

(30) Foreign Application Priority Data
Mar. 16, 2015 (GB) 1504385.4

(51) Int. Cl. C11B 9/00

(52) U.S. Cl. CPC C11B 9/00

(57) ABSTRACT

A perfume composition comprising at least 2 perfume ingredients, having a known Sandman Classifier (SC) value of at least 1.35. Preferred perfume compositions exhibit SC values of 1.35 to about 150, more particularly 1.35 to about 75, and still more particularly 1.35 to about 3. The composition enhances the quality of sleep.

The present invention relates to perfume compositions adapted to address sleep quality, and to consumer products containing said perfume compositions.

It has been observed that fragrance ingredients and essential oils can affect mood states, in particular, it has been suggested that they can create feelings of relaxation and well-being. However, the human perception of odour is subjective, and whereas individuals within a cultural group often share common associations with particular odours, these associations are not always recognised across cultures and regions. Lavender, for example, can elicit a deeply relaxing effect on western European consumers, but the association with relaxation might not be shared by people in other geographical regions.

While temporary, beneficial psychological effects of fragrance on human behaviours and emotions have been studied, very few studies have looked experimentally at the effects of fragrance on sleep quality. A few studies have suggested that odours can have a positive effect on sleep quality. However, these studies have relied mainly on the effects of single ingredients, or on very basic ingredient combinations that do not possess the hedonic performance and sophistication expected of a fragrance suitable for incorporation into consumer products. Some work has been undertaken to investigate the influence of odours on sleep patterns using electroencephalography (EEG). As is well known in the art, EEG is a method by which real-time brain activity is measured from the surface of the scalp at a high temporal resolution and therefore remains the most commonly used technique to describe differences between wakefulness and sleep.

Whereas the prior art suggests that certain odours can impact mood and emotion in human subjects and also influence sleep patterns, and whereas it is known that EEG is a technique that can measure brain activity in response to exposure to odours, to the applicant's best knowledge the prior art does not teach a reliable and objective method for selecting combinations of perfume ingredients that are both hedonically performant and sophisticated, and which are associated with improved sleep quality.

The applicant has addressed this deficiency in the prior art and provides means, which permit perfumers to create functional perfume accords, which both promote sleep quality, and at the same time are hedonically performant and sophisticated.

Accordingly, in a first aspect, the present invention provides a perfume composition comprising at least 2, more particularly at least 5, still more particularly 10 or more perfume ingredients, having a known Sandman Classifier (SC) value of at least 1.35. Preferred perfume compositions exhibit SC values of 1.35 to about 150, more particularly 1.35 to about 75, and still more particularly 1.35 to about 3.

The Sandman Classifier (SC) value of a perfume composition is derived from the measured brain wave activity of a human subject after the subject has inhaled said perfume composition. The brain wave activity is measured by EEG using the standard 10-20 electrode system. The SC value is provided by the following formula:

SC=((a1_{ce}+Θ_{ce})/δₜₑₘ)+(Θ/a2)
wherein:
a1_{ce} represents the amplitude value of alpha-1 brain wave activity with a frequency of oscillation between 8-12 hertz over the central electrodes C3, C4, Cz
Θ_{ce} represents the amplitude value of theta brain wave activity with a frequency of oscillation between 4-7 Hertz over the central electrodes C3, C4, Cz
δₜₑₘ represents the amplitude value of theta brain wave activity with a frequency of oscillation between 0.1-3 Hz over the temporal electrodes T7 and T8; and
Θ/a2 represents the ratio of the amplitude of theta brain wave activity with a frequency of oscillation between 4-7 Hertz over the amplitude value of alpha-2 brain wave with a frequency of oscillation between 12-15 hertz, across all electrodes.

In a particular embodiment of the present invention, the perfume compositions comprise perfume ingredients selected from:

A) about 1 wt % to about 30 wt %, more particular about 1.2 wt % to 28.9 wt %, based on the total amount of perfumery ingredients used in the perfume composition, of at least one citrus ingredient, in particular a citrus ingredient selected from the group consisting of:
Bergamot oils, essences, extracts, bases, substitutes or replacers, such as BERGAMOT OIL ITALY EXPRESSED; BERGAMOT REC ABX5638; BERGAMOTE GIVCO 104/4; CITRAL LEMAROME N; CITRAL TECH; CITRATHAL R; CITRONELLYL NITRILE; CLONAL; CYMENE PARA; DIHYDRO MYRCENOL; DIMETHYL OCTENONE; DIMETOL; FLOROPAL; Grapefruit oils, essences, extracts, replacers or substitutes, such as GRAPEFRUIT JUICE SUPER CONC 7108A or GRAPEFRUIT OIL COSMOS; lemon oils, essences, extracts, bases, substitutes or replacers, such as LEMON OIL CALIFORNIA TYPE DISTLD PURE; LEMON OIL ITALIAN ORPUR COSMOS; LEMON OIL RECONSTITUTION 1385; LEMON SPANISH DQ (AC) XN 41482TT; LEMONILE; LINALOOL OXIDE; LINALYL ACETATE SYNTHETIC; Litsea Cubeba oils, essences, extracts, replacers or substitutes, such as LITSEA CUBEBA OIL CHINA; mandarin oils, essences, extracts, bases, substitutes or replacers, such as MANDARIN ARTESSENCE OIL; MANDARIN OIL GREEN BRAZIL ORPUR; MANDARIN OIL ITALY COLOURLESS MD ORPUR; MANDARIN OIL WASHED COSMOS; MANDARINAL 32048 SAE; MANDARINAL 32048 SAE/2; MANDARINAL MATCH CF; METHYL PAMPLEMOUSSE; MYRCENE 90; orange oils, essences, extracts, bases, substitutes or replacers, such as ORANGE 49; ORANGE ALDEHYDE; ORANGE CALIFORNIAN DQ (AC) XN 41228TT; ORANGE OIL BRAZIL; ORANGE OIL COLORLESS N.S.; ORANGE OIL FLORIDA; ORANGE SAVON CONC OIL; ORANGE TERPENELESS DQ (AC) 41483TT; ORANGE TERPENES DISTILLED; petitgrain oils, essences, extracts, bases, replacers or substitutes, such as PETITGRAIN CITRONNIER OIL ORPUR; PRECYCLEMONE B; PRENYL ACETATE; RHUBAFURAN; Tamarine oils, essences, extracts, bases, replacers or substitutes, such as TAMARINE AB 8212; tangerine oils, essences, extracts, essence, bases, replacers or substitutes, such as TANGERINE SOUTH AFRICAN DQ AC XN 41957TT; TERPINENE GAMMA; TERPINOLENE; and TERPINYL ACETATE;
and at least one ingredient from at least five of the groups B1 through B20 in the amounts indicated:
B1) about 0.01 wt % to about 1.5 wt %, more particularly about 0.01 wt % to about 1.41 wt % based on the perfumery ingredients used in the perfume composition, of at least one aldehydic ingredient selected from the group consisting of: ALDEHYDE C 10 DECYLIC; ALDEHYDE C 11 UNDECYLENIC; ALDEHYDE C 110 UNDECYLIC; ALDEHYDE C 12 LAURIC; ALDEHYDE C 12 MNA PURE; ALDEHYDE C 8 OCTYLIC FOOD GRADE; ALDEHYDE C 9 ISONONYLIC; ALDEHYDE C 9 NONYLIC FOOD GRADE; ALDEHYDE C 90 NONENYLIC 1%/TEC; ALDEHYDE C12 (DODECANAL); ALDEHYDE ISO C 11; mandarine aldehydes, such as ALDEHYDE MANDARINE 10%/TEC; trans-4-decenal, such as DECENAL-4-TRANS, DECENAL-4-TRANS 10%/TEC; DIHYDROFARNESAL; dodecanal, such as DODECENAL 10%/TEC; MYRALDENE; and TANGERINOL;
B2) about 0.01 wt % to about 25 wt %, more particularly about 0.01 wt % to about 22.49 wt %, based on the perfumery ingredients used in the perfume composition, of at least one amber ingredient selected from the group consisting of: Amberketal, such as AMBERKETAL 1%/TEC; AMBERKETAL IPM; Ambermax, such as AMBERMAX 10%/TEC, AMBERMAX 50%/DOWANOL TPM; Ambrocenide, such as AMBROCENIDE 10%/DPG; AMBROFIX; AMBROFIX FLAKES; Belambre, such as BELAMBRE 50%/IPM; BOISAMBRENE FORTE; CEDRYL ACETATE LIQUID; CEDRYL METHYL ETHER; CETALOX; ISO E SUPER; KARANAL; KEPHALIS; TIMBEROL; TRIMOFIX O;
B3) about 0.01 wt % to about 1.5 wt %, more particularly about 0.01 wt % to about 1.41 wt % based on the perfumery ingredients used in the perfume composition, of at least one animalic/leather ingredient selected from the group consisting of: ANIMALIS 1745 SUBST. PMF 2; cade oils, essences, extracts, replacers substitutes, such as CADE OIL SPAIN; GUAIACOL; INDOFLOR; Indole, such as INDOLE, INDOLE 1%/TEC; Indolene, such as INDOLENE 50%/CASTOR OIL; Suederal ingredients, such as SUEDERAL LT 0710;
B4) about 0.01 wt % to about 0.2 wt %, more particularly about 0.01 wt % to about 0.16 wt % based on the perfumery ingredients used in the perfume composition, of at least one anisic ingredient selected from the group consisting of: ANETHOLE; ANISE STAR OIL; ANISIC ALDEHYDE; ANISYL ACETATE; DIHYDRO ANETHOLE; ESTRAGOLE; fennel sweet oils, essences, extracts, bases, replacers or substitutes, such as FENNEL SWEET 50% DQ (AC) 24190TT; FENNEL SWEET DQ (AC) N 41632TT; FENNEL OIL SWEET; FENNEL OIL SWEET TECH;
B5) about 0.01 wt % to about 0.2 wt %, more particularly about 0.01 wt % to about 0.13 wt % based on the perfumery ingredients used in the perfume composition, of at least one balsamic ingredient selected from the group consisting of: Benzoin oils, essences, extracts, replacers or substitutes, such as BENZOIN SI GU ETA 50% BB AAF0515 41235EH; BENZYL ALCOHOL; BENZYL CINNAMATE; Olibanum oils, essences, extracts, replacers or substitutes, such as OLIBANUM COEUR DEP FREE 50%/TEC; OLIBANUM OIL SOMALIA ORPUR; PHENYL ETHYL PHENYL ACETATE;
B6) about 0.01 wt % to about 10 wt %, more particularly about 0.01 wt % to about 8.13 wt % based on the perfumery ingredients used in the perfume composition, of at least one camphoraceous/aromatic ingredient selected from the group consisting of: Armoise oils, essences, extracts, replacers or substitutes, such as ARMOISE OIL MOROCCO ORPUR COSMOS; Camphor and Camphor oils, essences, extracts, replacers or substitutes such as CAMPHOR; CAMPHOR OIL WHITE; Eucalyptol and Eucalyptol oils, essences, extracts, replacers or substitutes, such as EUCALYPTOL; EUCALYPTUS GLOBULUS OIL CHINA COSMOS; Lavandin oils, essences, extracts, replacers or substitutes, such as LAVANDIN BRIALIS DQ (AC) XN 41665TT; LAVANDIN GROSSO OIL FRANCE ORPUR; LAVANDIN RGV 4; Lavender oils, extracts, essences, replacers or substitutes, such as LAVENDER DQ (AC) XN 41569TT; Rosemary oils, essences, extracts, replacers or substitutes, such as ROSEMARY OIL; ROSEMARY OIL RECONST; Thuja oils, essences, extracts, replacers or substitutes, such as THUJA OIL KOREA;
B7) about 30 wt % to about 80 wt %, more particularly about 32 wt % to about 79 wt % based on the perfumery ingredients used in the perfume composition, of at least one floral ingredient selected from the group consisting of: ACETAL CD; AMYL CINNAMIC ALDEHYDE; AMYL SALICYLATE; AURANTIOL PURE BENZYL ACETATE; BENZYL SALICYLATE; BOURGEONAL; CITRONELLOL; CITRONELLYL ACETATE; CRESYL METHYL ETHER PARA; CYCLAMEN ALDEHYDE EXTRA; CYCLOHEXAL; CYCLOHEXYL SALICYLATE; DIMETHYL ANTHRANILATE; DIMETHYL PHENYL THYL CARBINOL; DUPICAL; ETHYL LINALOOL; FLOROSA; FLOROSA HC; GERANIOL; Geranium oils, essences, extracts, replacers or substitutes, such as GERANIUM 230/3 MOD; GERANIUM ABQ5629; GERANIUM BOURBON DQ (AC) XN 41563TT; GERANODYLE; GERANYL ACETATE; GERANYL BUTYRATE; HEDIONE; HEDIONE HC; HEXENYL-3-CIS SALICYLATE; HEXYL CINNAMIC ALDEHYDE; HEXYL CINNAMIC ALDEHYDE DQ AC XI 41505TT; HEXYL SALICYLATE; HYDROXYCITRONELLAL; ISOBUTYL PHENYL ACETATE; ISOBUTYL SALICYLATE; JASMATONE; Jasmin oils, essences, extracts, replacers or substitutes, such as JASMIN ABSOLUTE DQ (AC) 41568TT; JASMIN ARGENT 2; JASMONE CIS; JASMONYL; JASMOPYRANE FORTE; LILIAL and lilial substitutes; LINALOOL; MEFROSOL; METHYL ANTHRANILATE; METHYL ANTHRANILATE EXTRA; METHYL BENZOATE; METHYL PHENYL ACETATE; Neroli oils, essences, extracts, replacers or substitutes, such as NEROLI ESSENTIAL BASE AB 7632; NEROLI PHASE ESS; NEROLINE CRYSTALS; NEROLIONE; Orange oils, essences, extracts, replacers or substitutes, such as ORANGE FLOWER TEC AB 2169E; ORANGER CRYSTALS; ORANGER FLEUR CREME 1103/20; PELARGOL; PEONILE; PETALIA; PHENYL ETHYL ACETATE; PHENYL ETHYL ALCOHOL; PHENYL ETHYL ISOVALERATE; PHENYL ETHYL SALICYLATE CRYSTALS; ROSACETOL; ROSALVA; Rose oils, essences, extracts, replacers or substitutes, such as ROSE BASE ABF0339A-K182572; ROSE TW 62/10/20; SUPER MUGUET; TERPINEOL PURE; TETRAHYDRO LINALOOL; VERDANTIOL; YARA YARA; Ylang oils, essences, extracts, replacers or substitutes, such as YLANG AB 0388A; YLANG ECO ESSENCE;
B8) about 0.01 wt % to about 22 wt %, more particularly about 0.01 wt % to about 21.08 wt % based on the perfumery ingredients used in the perfume composition, of at least one fruity ingredient selected from the group consisting of: ACETATE C 6 HEXYLIC; AGRUMEX; ALLYL AMYL GLYCOLATE; ALLYL CAPROATE; ALLYL CYCLOHEXYL PROPIONATE; ALLYL OENANTHATE; AMYL BUTYRATE; APHERMATE; Apple oils, essences, extracts, replacers or substitutes, such as APPLE BASE ABF1016-K108004; Banana oils, essences, extracts, replacers or substitutes, such as BANANA BASE ABF0961A-K108784; BENZYL BUTYRATE; BENZYL ISOBUTYRATE; BENZYL PROPIONATE; BUTYL ACETATE; BUTYRIC ACID; Cassis oils, essences, extracts, replacers or substitutes, such as CASSIS BASE 345-F CS/4/20; CASSIS BASE 345B RECO TEC AB 8408D; COGNAC WHITE OIL EXTRA DQ (AC) 41547TT; CYCLOGALBANATE; DAMASCENONE; DAMASCONE ALPHA; DAMASCONE BETA; DAMASCONE DELTA; DECALACTONE DELTA; DECALACTONE GAMMA; Dewfruit oils, essences, extracts, replacers or substitutes, such as DEWFRUIT/2; DEWFRUIT TEC AB 2927R LILIAL FREE; DIETHYL MALONATE; DIMETHYL BENZYL CARBINYL ACETATE; DIMETHYL BENZYL CARBINYL BUTYRATE; DODECALACTONE DELTA; DODECALACTONE GAMMA; ETHYL ACETOACETATE; ETHYL BUTYRATE; ETHYL CAPROATE; ETHYL CAPRYLATE; ETHYL ISOAMYL KETONE; ETHYL ISOBUTYRATE; ETHYL METHYL-2-BUTYRATE; ETHYL OENANTHATE; ETHYL PELARGONATE; ETHYL PROPIONATE; ETHYL SAFRANATE; FLOROCYCLENE; FRAISTONE; FRUCTONE; FRUITATE; GARDOCYCLENE; GIVESCONE; Guave oils, essences, extracts, replacers or substitutes, such as GUAVE DUPLICATION/2; HEXENYL-3-CIS BUTYRATE; HEXENYL-3-CIS ISOBUTYRATE; HEXYL BUTYRATE; HEXYL ISOBUTYRATE; ISOAMYL ACETATE EXTRA; ISOAMYL BUTYRATE FR; JASMACYCLENE; MANZANATE; Melon oils, essences, extracts, replacers or substitutes, such as MELON HONEYDEW/2; METHOXY PHENYL BUTANONE; METHYL HEPTENONE PURE; METHYL HEXYL KETONE; METHYL-2-PENTENOIC ACID; 2-NECTARYL; OCTALACTONE GAMMA; PEACH PURE; PHENOXY ETHYL ISOBUTYRATE; PHENYL ETHYL ISOBUTYRATE; PRUNOLIDE; RASPBERRY KETONE (N112); STRAWBERRY PURE;
B9) about 0.001 wt % to about 0.01 wt %, more particularly about 0.001 wt % to about 0.002 wt % based on the perfumery ingredients used in the perfume composition, of at least one fungal ingredient selected from the group consisting of: AMYL VINYL CARBINOL; OCIMENE
B10) about 0.01 wt % to about 1 wt %, more particularly about 0.01 wt % to about 0.86 wt % based on the perfumery ingredients used in the perfume composition, of at least one gourmand ingredient selected from the group consisting of: ACETOIN; Acetyl pyrazine, such as ACETYL PYRAZINE 1%/TEC; BENZALDEHYDE; BUTYL BUTYRO LACTATE; Chocolate oils, essences, extracts, replacers or substitutes, such as CHOCOLAT NOIR 1130 TEC/3; CORYLONE DRIED; CYCLOTENE; Ethyl maltol, such as ETHYL MALTOL; ETHYL MALTOL 1%/BA; Homofuronol, such as HOMOFURONOL 20%/TEC; Hydroxy ethyl methyl thiazol, such as HYDROXY ETHYL METHYL THIAZOL 10%/TEC; ISOBUTAVAN; MALTYL ISOBUTYRATE;
B11) about 0.01 wt % to about 5 wt %, more particularly 0.041 wt % to about 4.28 wt % based on the perfumery ingredients used in the perfume composition, of at least one green ingredient selected from the group consisting of: ACETAL E; ALCOHOL C 6 HEXYLIC; ALDEHYDE C 6 HEXYLIC FOOD GRADE; BUTYL QUINOLINE SECONDARY; CYCLAL C; DIPHENYL OXIDE; ELINTAAL; ETHYL DECADIENOATE; ETHYL DIMETHYL Pyrazine, such as PYRAZINE 1%/TEC; Galbanone, such as GALBANONE 10; GALBANONE PURE; GARDENOL; Hexenal-2-trans, such as HEXENAL-2-TRANS 10%/TEC; HEXENOL-2-TRANS; HEXENOL-3-CIS; HEXENYL-3-CIS ACETATE; HEXENYL-3-CIS BENZOATE; HEXENYL-3-CIS PROPIONATE; ISOCYCLOCITRAL; Isohexylmethoxy pyrazine, such as ISOHEXYLMETHOXY PYRAZINE 1%/TEC; LIFFAROME; LIGANTRAAL; MACEAL; METHYL OCTYNE CARBONATE; NEOFOLIONE; Nonadienal, such as NONADIENAL; NONADIENAL 1%/TEC; NONADIENOL-2,6; Nonenal-6-cis, such NONENAL-6-CIS 10%/TEC; NONENOL-6-CIS; Petitgrain oils, essences, extracts, replacers or substitutes, such as PETITGRAIN ECO ESSENCE; PETITGRAIN OIL PARAGUAY; Phenoxyacetaldehyde, such as PHENOXY ACETALDEHYDE 50; Phenyl acetaldehyde, such as PHENYL ACETALDEHYDE 50%/PHENYL ETHYL ALC; PYRALONE; RESEDAL; ROSE OXIDE; ROSYRANE SUPER; STEMONE; TRICYCLAL; TRIFERNAL; UNDECATRIENE; UNDECAVERTOL; Violet nitrile, such as VIOLET NITRILE 0.1%/TEC; VIOLET NITRILE 10%/TEC; VIRIDINE;
B12) about 0.01 wt % to about 0.5 wt %, more particularly 0.01 wt % to about 0.1 wt % based on the perfumery ingredients used in the perfume composition, of at least one herbal ingredient selected from the group consisting of: Basil oils, essences, extracts, replacers or substitutes, such as BASIL OIL EGYPT ORPUR; Camomile oils, essences, extracts, replacers or substitutes, such as CAMOMILE ENGLISH DQ (AC) XN 41528TT; CITRONELLAL; Clary sage oils, essences, extracts, replacers or substitutes, such as CLARY SAGE OIL COSMOS; CLARY SAGE OIL FRANCE ORPUR; CYPRISATE; Eucalyptus oils, extracts, essences, replacers or substitutes, such as EUCALYPTUS CITRIODORA OIL BRAZIL; HERBOXANE; PINOACETALDEHYDE; TANAISONE; Thyme oils, essences, extracts, replacers or substitutes, such as THYME OIL RED 40-45%; THYME WHITE DQ (AC) XN 41491TT; THYMOL CRYSTALS;
B13) about 0.01 wt % to about 5 wt %, more particularly about 0.01 wt % to about 4.3 wt % based on the perfumery ingredients used in the perfume composition, of at least one marine/watery ingredient selected from the group consisting of: ADOXAL; Azurone, such as AZURONE 10%/TEC; CALONE 1951; FENNALDEHYDE; FLORALOZONE; FLORHYDRAL; MELONAL; SCENTENAL; TROPIONAL; VERNALDEHYDE;
B14) about 0.01 wt % to about 0.5 wt %, more particularly about 0.01 wt % to about 0.47 wt % based on the perfumery ingredients used in the perfume composition, of at least one mint ingredient selected from the group consisting of: Buchu leaf oils, essences, extracts, replacers or substitutes, such as BUCHU LEAF OIL SOUTH AFRICA COSMOS; CARVONE LAEVO; Cornmint oils, essences, extracts, replacers or substitutes, such as CORNMINT OIL DEMENTHOLIZED; FRESKOMENTHE; ISOMENTHONE DL; MENTHOL LAEVO; MENTHOL-DL; MENTHONE; MENTHYL ACETATE; Peppermint oils, essences, extracts, replacers or substitutes, such as PEPPERMINT AM FAR WEST DQ AC 41624TT; PEPPERMINT AM MID WEST MIW DQ AC 41253TT; PEPPERMINT AM WILL REDIST DQ AC 24150TT; PEPPERMINT AM WILLAM NAT DQ AC 37968TT; PEPPERMINT AMER 9303 DQ (AC) 37934TT; PEPPERMINT CHINESE T'LES(EXCN)DQ 24329TT; PEPPERMINT CHINESE TR (CN) DQ 24109TT; PEPPERMINT CN TERPLESS FDC DQ AC 37921TT; PEPPERMINT HMF DQ 24817TT; PEPPERMINT INDIAN TPC-1 DQ AC 24049TT; PEPPERMINT OIL BLEND; PEPPERMINT PIP IND REC.FDC DQ AC 24040TT; Spearmint oils, essences, extracts, replacers or substitutes, such as SPEARMINT AM FW NAT DQ AC XN 41610TT; SPEARMINT OIL USA TYPE;
B15) about 0.01 wt % to about 50 wt %, more particularly about 0.01 wt % to about 44.43 wt % based on the perfumery ingredients used in the perfume composition, of at least one musk ingredient selected from the group consisting of: AMBRETTOLIDE; CASHMERAN; COSMONE; Cyclopentadecanolide, such as CYCLO PENTA DECANOLIDE DQ 1% PG; ETHYLENE BRASSYLATE; GALAXOLIDE; GALAXOLIDE S; HABANOLIDE; MUSCENONE; MUSK C14; SERENOLIDE; SILVANONE SUPRA; SYLKOLIDE; VELVIONE;
B16) about 0.01 wt % to about 10 wt % based on the perfumery ingredients used in the perfume composition, of at least one orris ingredient selected from the group consisting of: CETONE V; DIHYDRO IONONE BETA; IONONE BETA; IRISONE ALPHA; IRISONE PURE; ISORALDEINE 70; ISORALDEINE 95; ORIVONE;
B17) about 0.01 wt % to about 1 wt %, more particularly about 0.01 wt % to about 0.45 wt % based on the perfumery ingredients used in the perfume composition, of at least one spicy ingredient selected from the group consisting of: Cardamom oils, essences, extracts, replacers or substitutes, such as CARDAMOM SEED OIL ORPUR; CARDAMOM SUBSTITUTE 1527 F; CARDAMOME SUBSTITUT 1527 F/2; CARYOPHYLLENE; CINNAMIC ALCOHOL CINNAMIC ALCOHOL; CINNAMIC ALDEHYDE; Cinnamon leaf oils, essences, extracts, replacers or substitutes, such as CINNAMON LEAF OIL WASHED ORPUR; Clove oils, essences, extracts, replacers or substitutes, such as CLOVE BUD OIL; CLOVE LEAF OIL COLORLESS; CLOVE LEAF OIL RECTIFIED RB COSMOS; Coriander oils, essences, extracts, replacers or substitutes, such as CORIANDER SEEDS OIL ORPUR COSMOS; Elemi oils, essences, extracts, replacers or substitutes, such as ELEMI RESINOID 50%/BB; ETHYL CINNAMATE; EUGENOL; Ginger oils, essences, extracts, replacers or substitutes, such as GINGER OIL INDIA ORPUR; GINGER ROOT FRESH CUT; ISOEUGENOL; IMETHYL CINNAMATE; METHYL ISOEUGENOL; MYSTIKAL; Nutmeg oils, essences, extracts, replacers or substitutes, such as NUTMEG OIL INDONESIA; Pepper oils, essences, extracts, replacers or substitutes, such as PEPPER BLACK OIL MADAGASCAR ORPUR; SZECHUAN PEPPER (ASH BARK) DQ AF 24070TT;
B18) about 0.01 wt % to about 0.5 wt %, more particularly about 0.01 wt % to about 0.21 wt % based on the perfumery ingredients used in the perfume composition, of at least one sulphurous ingredient selected from the group consisting of: Anjeruk, such as ANJERUK 0.01%/TEC; Corps cassis, such as CORPS CASSIS 0.1%/TEC; CORPS CASSIS 10%/TEC; Corps pamplemousse, such as CORPS PAMPLEMOUSSE PURE 1%/TEC; CORPS PAMPLEMOUSSE PURE 10%/TEC; Dimethyl sulphide, such as DIMETHYL SULFIDE; DIMETHYL SULFIDE 1%/TEC; GARDAMIDE; Labienoxime, such as LABIENOXIME 1%/IPM-TEC; Mercaptans, such as MERCAPTO-8 MENTHENE-1 PARA 0.1% IN TEC; METHYL ISOPROPYL THIAZOLE; Nardozeste oils, essences, extracts, replacers or substitutes, such as NARDOZESTE ABQ5031; NEOCASPIRENE EXTRA; NONIVAMIDE 1% TRIACETIN; Oxane, such as OXANE 50%/TEC; PARADISAMIDE; Paramenthone, such as PARAMENTHONE 1%/TEC;
B19) about 0.01 wt % to about 10 wt %, more particularly about 0.2 wt % to about 7.83 wt % based on the perfumery ingredients used in the perfume composition, of at least one sweet/powdery ingredient selected from the group consisting of: ACETOPHENONE; AUBEPINE PARA CRESOL; BICYCLO NONALACTONE; COUMARIN; Ethyl laitone, such as ETHYL LAITONE 1%/TEC; ETHYL VANILLIN; HELIOTROPIN Vanilla oils, essences, extracts, replacers or substitutes, such as VANILLA ABSOLUTE 20 FOLD DQ AC 41493TT; VANILLA S/ABS DEC 50% PG AAF0517 L228655; VANILLA SUP ABS DEC DQ P17 SB AC 41561TT; VANILLAL DQ (AF) 41319TT; VANILLIN; VANILLIN DQ (AF) 41320TT; Vanolia oils, essences, extracts, replacers or substitutes, such as VANOLIA BASE ABF0303B; VERATRIC ALDEHYDE;
B20) about 0.01 wt % to about 15 wt %, more particularly about 0.01 wt % to about 10.37 wt % based on the perfumery ingredients used in the perfume composition, of at least one woody/pine ingredient selected from the group consisting of: BORNEOL; BORNYL ACETATE LIQUID; BUTYL CYCLOHEXANOL PARA; BUTYL CYCLOHEXYL ACETATE PARA; Cedar wood oils, essences, extracts, replacers or substitutes, such as CEDARWOOD OIL USA VIRGINIA TYPE ORPUR; CONIFERAN; EBANOL; EVERNYL; FENCHYL ACETATE; Guaiac wood oils, essences, extracts, replacers or substitutes, such as GUAIACWOOD OIL PARAGUAY; ISONONANYL ACETATE; JAVANOL; KOHINOOL; MENTHANYL ACETATE; METHYL CEDRYL KETONE; NOPYL ACETATE; OSYROL; OXYOCTALINE FORMATE; Patchouli oils, essences, extracts, replacers or substitutes, such as PATCHOULI OIL COLORLESS INDONESIA; PATCHOULI OIL IRONFREE INDONESIA COSMOS; PINENE ALPHA; PINENE BETA; RADJANOL; RADJANOL SUPER; Turpentine oils, essences, extracts, replacers or substitutes, such as TURPENTINE OIL RECTIFIED; VERTOFIX COEUR; Vetiver oils, essences, extracts, replacers or substitutes, such as VETIVER OIL HAITI ORPUR ORGANIC COSMOS;
and optionally
B21) about 0.01 wt % to about 10 wt % based on the perfumery ingredients used in the perfume composition, of at least one ingredient selected from the group consisting of: ALDEHYDE C12 (DODECANAL; MENTHYL ACETATE;

Where trivial names are used to describe useful perfume ingredients hereinabove, the skilled perfumer would understand that these are commonly used names by perfumers. However, the skilled perfumer would also understand that these ingredients may also be known by other trivial synonyms, by CAS registry numbers, or by more formal nomenclature, such as IUPAC nomenclature. Furthermore, the skilled perfumer would by familiar with these other trivial synonyms, as well as with more formal nomenclature, or at the least, would be aware of standard reference works, such as The Good Scent Company web site, which contains a comprehensive list of trivial names, registry numbers and more formal nomenclature for the perfume ingredients contained on the perfumers palette.

The perfume compositions of the present invention may be entirely comprised of perfume ingredients referred to hereinabove. These perfume ingredients may be referred to as “functional perfume ingredients”. Alternatively, the functional perfume ingredients may form only a part of the perfume composition.

In a particular embodiment of the present invention, the perfume ingredients represent 0.1 wt % to 100 wt % of the perfume composition, more particularly 8.5 wt % to 100 wt %, and still more particularly 34 wt % to 71 wt %.

In addition to the functional perfume ingredients referred to hereinabove, the perfume compositions of the present invention may contain other perfume ingredients. A comprehensive list of other suitable perfume ingredients may be found in the perfumery literature, for example “Perfume & Flavor Chemicals”, S. Arctander (Allured Publishing, 1994), as well as later editions of this work, which are herein incorporated by reference.

Perfume compositions of the present invention may contain other, non-perfumery, ingredients. In particular ingredients or excipients conventionally used in conjunction with fragrances in perfume compositions, for example carrier materials, and other auxiliary agents commonly used in the art, e.g., solvents such as dipropylene glycol (DPG), isopropyl myristate (IPM), benzyl acetate (BA), propylene glycol (PG) and triethyl citrate (TEC).

The perfume compositions of the present invention may be presented in the form of free-oil, or they may be encapsulated. Several encapsulating media are known in the art for encapsulating perfume formulations and they are all suitable for use in the present invention. Particular encapsulating media include microcapsules formed of aminoplast resins, such as melamine-formaldehyde resins, polyurea, polyamide, as well as copolymers of acrylic acid, methacrylic and their esters.

Perfume compositions of the present invention may be used to impart desirable odour impressions on all manner of consumer products. Preferably, however, they are incorporated into those consumer products, which are used by consumers during sleep, or in preparation for sleep, or are in the immediate vicinity of consumers as they sleep. More particularly, perfume compositions of the present invention may be employed in laundry care applications, personal care products for treating hair and skin of human subjects, oral care products, and air care products.

Accordingly, in another aspect of the present invention, there is provided a consumer product comprising a perfume composition as herein defined.

In a particular aspect of the present invention the consumer product is a laundry care product. Laundry care products include powder and liquid detergents and fabric softeners, stain removers and pre-wash treatments, conditioners & softeners (including standard and concentrated conditioners, softeners and dryer sheets); laundry aids (including stain removers, ironing aids, whiteners and colour care products and other ancillary fabric care products); laundry detergents (including machine wash liquid detergents, other machine wash detergents (including powders, capsules and tablets) and hand wash detergents (powders, flakes and cakes/bars); sheet spray; clothing spray; laundry fragrance; dryer sachets; perfumed sachets; dryer sheets; laundry soap; laundry detergent; detergent for delicates; ironing spray; starch; fragrance sheets; pillow mists; drawer liner sheets; cedar closet spray; linen water and refills and combinations thereof.

Laundry care products contain laundry cleaning actives. Laundry cleaning actives are substances which play an active role in the cleaning process of laundry. Cleaning actives include, but are not limited to, substances such as detersive surfactants (anionic, nonionic, cationic, zwitterionic, and amphoteric surfactants), builders (inorganic and organic builder substances), bleaches, bleach activators, bleach stabilizers, bleach catalysts, enzymes, soil suspending or dispersing polymers, chelants, or combinations thereof, without the term being restricted to these substance groups.

Laundry care products may contain one or more of soil release polymer, anti-oxidants, colorants, preservatives, optical brighteners, opacifiers, stabilizers such as guar gum and polyethylene glycol, anti-shrinkage agents, anti-wrinkle agents, soil release agents, fabric crisping agents, reductive agents, spotting agents, germicides, fungicides, anti-corrosion agents, antifoam agents, hueing dyes, and the like.

Laundry care products may contain fabric softening actives. Non-limiting examples include silicone, fatty acid, fatty esters, polyglycerol esters, polyethylene waxes, sucrose esters, clays, triglycerides, cationic starches, and cationic polymers.

In another aspect of the invention the consumer product is a personal care product. Personal care products include, soaps, shower gel, body creams, body lotions, body mists, perfumery, cosmetics, floating bath oils, after shaves, creams, lotions, deodorants, including stick deodorants, pre-electric shave lotions, after-shave lotions, antiperspirants, shampoos, conditioners and rinses and related products, among others, including skin care products, eye makeups, body shampoos, protective skin formulations, lipsticks, lip glosses, after-bath splashes, pre-sun and sun products, including sunscreens. Virtually any chemical product which comes into contact with the hair or skin and which may include effective amounts or concentrations of one or more of the compositions according to the present invention may be considered a personal care product according to the present invention.

In another particular aspect of the invention the consumer product is an oral care product. Oral care products include toothpaste, dental cream, gel or tooth powder, odontic, mouth washes, including plaque removing liquids, typically comprise a water/alcohol solution, humectant, sweetener, foaming agent, colorant, and optionally enzymes; pre- or post-brushing rinse formulations, chewing gum, lozenges, and candy. Toothpastes and tooth gels typically include abrasive polishing materials, foaming agents, flavouring agents, humectants, binders, thickeners, sweetening agents, whitening/bleaching/stain removing agents, water, and optionally enzymes.

In yet another particular aspect of the present invention, the consumer product is an air care product. Air care products include candles, air-freshener devices, such as liquid electrical air-freshener devices, aerosol sprays, pump action sprays, fragranced candles, membrane permeation devices, Liquid wick devices, oil based gel fragrances, aqueous gels.

Air care products may contain one or more fragrance ingredients, having a vapour pressure that is less than 0.01 mmHg at 25 degrees centigrade. Suitable fragrance ingredients are set forth in S. Arctander “Perfume and Flavor Chemicals: Volume 1, Allured Publishing Corporation 1969, or any later editions thereof, as well as the IFRA (International Fragrance Research Association) database, and RIFM (Research Institute of Fragrance Materials) database, each of which and hereby incorporated by reference in their entirety.

Furthermore, air care products may contain one or more low vapour pressure solvents or carriers to aid the evaporation of the fragrance ingredients mentioned hereinabove.

Low vapour pressure solvents are defined herein as organic solvents that have a vapour pressure less than 0.1 mmHg at 20 degrees centigrade and which are included as approved for use by the California Air Resources Board (CARB) as so-called LVPVOC “low vapour pressure volatile organic compound”. Examples of low vapour pressure solvents include dipropylene glycol methyl ether acetate (DPMA), available under the brand name Dowanol® DPMA, Dowanol TPM (tripropylene glycol methyl ether), Dowanol DPNB (propylene glycol n-butyl ether, Dowanol DPNP (propylene glycol n-propyl ether), and other suitable Dow Chemical Dow P-series glycol ethers.

The low vapour pressure solvent may be present in amounts of 10% or more based on the total weight of perfume compositions used in air care products, more particular 20% or more, still more particularly 30% or more. The upper range of low vapour pressure solvent may be up to 60%, more particularly up to 70% and still more particularly up to 80% based on the total weight of the composition used in an air care product.

In addition to, or in place of said low vapour pressure solvents, a perfume composition of the present invention may contain one or more perfume ingredients, which have similar evaporation properties as the CARB VOCs mentioned above. Suitable perfume ingredients are those described in EP 2 328 625 (and its equivalents), which are hereby incorporated by reference, as so-called “FPC” ingredients. FPC ingredients include but are not limited to iso-nonylacetate, dihydromyrcenol, linalool, geraniol, d-limonene, and benzyl acetate.

Perfume compositions may additionally comprise a carrier material consisting of one or more volatile aroma chemicals. Volatile aroma chemicals are defined as a group of perfume ingredients that have high volatility, e.g. a vapour pressure at 25 degrees centigrade of 0.1 mmHg or higher, more particularly at least about 0.2 mmHg, or at least about 0.5 mmHg, or at least 1 mmHg.

Exemplary volatile aroma chemicals include hexyl acetate, 3,3,5-trimethylhexyl acetate, bornyl formate, 3-hexenyl butyrate, phenyl ethyl acetal, butyl hexanoate, isononanol, acetone alcohol, isoprenyl acetate, isobutyl 2-pentanoate, amyl propionate, herbal dioxane, furfuryl formate, methyl acetyl acetone, and butyl acetoacetate.

Other volatile aroma chemicals are selected from any of the compounds set forth in Table 1 of U.S. Pat. No. 8,603,963, which is hereby incorporated by reference.

In addition to the aforementioned materials, compositions of the present invention may contain one or more active agents selected from the group consisting of an agent that provides fabric conditioning or softening, fabric refreshing, air freshening or deodorising, malodour removal. Active agents might also include surfactants emulsifiers, solubilizers, polymers, malodour counteracting agents, buffers, zinc ions, and the like.

Air care devices suitable for use with compositions according to the present invention include electrical air freshening devices, which refers to a device or system that includes an electrical or battery source of energy. The term “electrical air freshening device includes heated liquid wick systems, piezoelectrical spraying systems, electrospray devices and Venturi devices, as well as devices that are powered by solar or other alternative forms of energy.

Any suitable size, shape, form, or configuration of device can be used. Suitable devices can be made from any suitable material, including but not limited to: natural materials, man-made materials, fibrous materials, non-fibrous materials, porous materials, non-porous materials, and combinations thereof.

In certain embodiments, a typical device utilizes a combination of a wick, and an emanating surface to dispense a liquid composition a liquid composition reservoir.

Devices (such as, “wicking devices”) are known for dispensing volatile liquids into the atmosphere, such as fragrance, deodorant, disinfectant or insecticide active agent. A typical air care device utilizes a combination of a wick and emanating surface to dispense a volatile liquid from a liquid fluid reservoir. Devices should perform in a manner that allows the liquid composition to be dispensed at a steady and controlled rate into an ambient atmosphere while maintaining a coherent olfactive profile over the life span of the device.

In an embodiment of the invention, a device includes an electrical or battery operated source of energy which includes heated liquid wick delivery systems, piezoelectrical spraying systems, electrospray devices or Venturi devices. Commercial examples of electrical liquid air freshner devices include, but are not limited to, Glade® PlugIns® Scented oil, sold by SC Johnson & Sons; Air Wick Scented Oils, and Air Wick X-Press® Scented Oils, sold by Reckitt Benckiser; Febreze Noticeables sold by Proctor & Gamble Co., Electric Home Air Fresheners, sold by the Yankee Candle Co.; and Renuzit Scented Oils, sold by Henkel AG.

Perfume compositions according to the present invention find utility as perfumes that can be dispensed from all manner of fragrance dispensing devices referred to hereinabove.

Perfume compositions according to the present invention evaporate in a controlled fashion. In particular, the evaporation rate, measured as weight of fragrance loss, per unit of time ranges from 0.2-0.6 g/day over a given time period, e.g., 30, 40 or 60 days, is relatively constant over the given time period. Evaporation rates are substantially constant, for example weight of fragrance loss per unit of time differs by less than +−5%, or +−10% or +−20% over the given time period.

Furthermore, evaporation rates are such that the reservoir containing liquid composition according to the invention is empty, or substantially so, before the rate decays to a level below 0.2 g/day.

The level of incorporation of the perfume compositions into the consumer product can vary within wide limits, and will depend to some extent on the particular application and consumer product in question. In liquid electrical air care devices, for example, it is common for the entire composition that is to be evaporated to consist of perfume composition.

A range of incorporation of the perfume composition is about 1 wt % to about 100 wt % based on to total weight of the consumer product, more particularly about 1 wt % to 60 wt %, still more particularly about 0.01 wt % to 25 wt %.

In a particular embodiment of the present invention, a perfume composition for use in an air freshener composition comprises from about 0.01 wt % to 25 wt % of functional perfume ingredients, based on the weight of the air freshener composition.

In another particular embodiment, a perfume composition for use in an oral care composition comprises about 0.01 wt % to about 60 wt % of functional perfume ingredients based on the weight of the oral care composition.

In yet another particular embodiment, a perfume composition for use in a fabric care composition comprises about 0.01 wt % to about 20 wt % of functional perfume ingredients, based on the weight of the fabric care composition.

In yet another particular embodiment, a perfume composition for use in a personal care composition comprises about 0.01 wt % to about 20 wt % of functional perfume ingredients, based on the weight of the personal care composition.

In a particular aspect of the present invention the consumer product is a home care product. Home care products can be used particularly for cleaning, rinsing, care or treatment of industrial, domestic or communal hard surfaces, as well as textile article surfaces; they are targeted at conferring on the surfaces treated therewith benefits such as water repellency, soil release, stain resistance, anti-fogging, surface repair, anti-wrinkling, shine, lubrication and/or at improving the residuality, impact and or efficacy of active materials comprised in said compositions. Hence home care compositions according to the invention include: surface cleaning compositions (for example, glass, floor, counter, bath, toilet bowl, sink, appliance and furniture cleaning compositions); disinfectants (for example, spray and solid air disinfectants (including gel); and spray, solid, liquid and paste surface disinfectants); waxes and other surface protecting and/or polishing compositions; and rug shampoos. The home care compositions can include additional components, such as enzymes, bleaches, whiteners, color care agents, fabric softeners, suds suppressors, dispersants, dye transfer inhibitors, chelating agents, aerosol propellants, gelling agents, thickening agents and a combination thereof.

In yet another particular embodiment, a perfume composition for use in a home care composition comprises about 0.01 wt % to about 34 wt % of functional perfume ingredients, based on the weight of the home care composition.

The perfume compositions of the present invention are designed according to perfumery rules that address sleep quality, as well as to provide performant and desirable hedonic accords suitable for particular consumer product applications. More particularly, the perfume compositions are selected from combinations of functional perfume ingredients, and on the basis of the SC values of those combinations of ingredients.

Accordingly, in another aspect of the present invention there is provided a method of preparing a perfume composition for addressing sleep quality, said method comprising the step of combining functional perfume ingredients in a manner such that said combination has a Sandman Classifier value greater than 1.35.

In yet another aspect of the present invention, there is provided a method of preparing a consumer product comprising the step of incorporating into a consumer product base, a perfume composition as herein defined, having a known Sandman Classifier value greater than 1.35.

The applicant has carried out extensive studies into the relationship between perfume compositions and the sleep quality of human subjects who have inhaled said compositions. The studies have employed both consumer tests, as well as measurements of brain electrical activity using electroencephalography (EEG) and statistical analysis of the resulting data. In this way, the applicant has elucidated a new parameter, which enables perfumers to design, in an objective manner, performant and sophisticated perfume compositions that positively impact the quality of sleep.

The applicant will now further illustrate the invention with reference to examples, as well as a detailed description of the EEG and consumer testing methodologies.

The Sandman Classifier (SC) value has been determined by an electroencephalography (EEG) test using the standard 10-20 electrode system.

The 10-20 system is a well-known and standardized method to describe and apply the location of scalp electrodes in relation with the underlying area of the cerebral cortex. No detailed description needs to provided herein, and the applicant simply draws attention to Jasper H H. The ten-twenty electrode system of the International Federation. Electroencephalogr Clin Neurophysiol 1958; 10:371-375, which is herein incorporated by reference.

25 female participants took part in this experiment (age range 32-52 years). All participants gave informed consent to take part in the test.

Perfume compositions were prepared by pipetting 0.1 g of fragrance oil into a sorborod and leaving for 24 hours. Five perfume compositions were included for comparison in the test, in addition to one odourless control (a blank sorborod). Each composition was presented once during the test. The order in which the perfume compositions were presented was counterbalanced across participants.

The test consisted of two elements, which were repeated multiple times through the experimental session: The first element consisted of an alert/active task, whereas the second consisted of a relaxing task. For the alert/active task, the participants performed a short maths task for 2 minutes to ensure that they were in an alert state. Following this two minute maths task, participants then performed the relaxing task. During the relaxing task, EEG was recorded as participants sat comfortably while wearing an eye mask to eliminate unwanted visual stimulation (e.g. from the presentation of the sorborod). Participants were instructed at the start of the experiment, that for this part they were required to close their eyes and sit in an awake, but relaxed state, avoid unnecessary movements/muscle tension and continue breathing as normal. Immediately after participants had closed their eyes, a perfume composition was presented to the participant using sorborods held approximately 5-6 cm under the nose. The perfume composition was held under the nose for 5 minutes. At the end of the 5 minutes, participants then opened their eyes and completed a questionnaire which contained ratings about their mood and about the fragrance. Following this, participants then performed the alert state maths task again, followed by the relaxing task before being presented with the next perfume composition. This test was repeated for all perfume compositions. Each perfume composition/sorbarod (4 compositions & 1 odourless blank) was presented twice during the task which meant that the participants performed 10 maths tasks, and 10 relaxing tasks in total (FIG. 10).

In each experiment, EEG was recorded using a NuAmp amplifier (Neuroscan, El Paso, Tex.) from 18 scalp sites using Ag/AgCl electrodes mounted on an elastic cap (Easy Cap), positioned according to the 10-20 International system (AEEGS, 1991). The montage included four midline sites (FZ, FCZ, CZ, PZ) and 7 sites over each hemisphere (FP1/FP2, F3/F4, FC3/FC4, C3/C4, CP3/CP4, P3/P4, O1/O2). Additional electrodes were used as ground and reference sites. The right mastoid (behind the ear) was used as the active reference. Data were then re-referenced off-line to the algebraic average of the right and left mastoids. Respiratory signals were simultaneously recorded using a piezo-electric sensor embedded within an abdominal respiratory band. The EEG signal was digitized at a sampling rate of 1000 Hz. Data were recorded with a low-pass filter of 300 Hz and with no high-pass filter (DC). Digital codes were sent to the EEG recording computer during an experiment to mark the presentation of the odour stimuli.

For each experiment, EEG data were filtered off line with a band pass filter ranging from 1-50 Hz. Digital codes marked the time at which the odour stimulus was presented (during expiration), the code timings were then aligned with the start of the following inspiration, using markers from the respiratory band trace. This ensured that all odour stimuli were aligned in time across trials and aligned with the onset of inspiration. The EEG recordings were made within the time-window of odour presentation. Intervals of measurement containing excessive noise or drift (+/−50 μV) were rejected. Additionally, all trials were visually inspected for smaller artifacts and drifts and discarded if necessary.

Data from the time window of interest (each 5 minutes of fragrance/sorbarod presentation) was analyzed according to the frequency domain using Fast-Fourier Transform (FFT) analysis, according to methods generally known in the art. FTT analysis transforms the EEG signals into a power spectrum where the X axis reflects frequency (Hz) and the Y axis reflects power (power reflects both the amplitude of each frequency of waves within that time window as well as the relative amount of those waves, i.e. how often each specific frequency of waves was present within the window). The main frequency band of interest for this experiment was the alpha band (8-12 Hz) as this band has previously been associated with relaxation.

Frequency analysis was performed for each participant, for each fragrance condition separately (averaged across the two replicates). Data across the whole group of participants was then averaged to produce averaged frequency spectra for each fragrance condition. Frequency spectra responses were compared between the fragrance and no-fragrance conditions, and also between the individual fragrance conditions. Statistical analysis (ANOVA) was then performed on the specific frequency band of interest (alpha band) to test for significant differences between conditions. Analysis was conducted across different brain regions to examine more specific effects across frontal and posterior sites.

The EEG test data were validated against the results of a sleep study to determine if EEG data were correlated to actual sleep experiences.

Seventy women in the age range 25-60, were initially pre-screened using a pre-established questionnaire for their suitability and eligibility to take part. 20 participants (aged 34-56) were selected based on agreed criteria including sleep performance, lifestyle, nighttime routine, general health and fragrance allergies. All participants gave informed consent before taking part. Participants were selected on the basis of them having average or below average sleep quality (i.e. neither good sleepers nor very poor sleepers). Participants were asked to maintain their usual sleeping habits and night time routines throughout the study, avoiding excessive alcohol.

Different test perfume compositions were selected for use in the study. The ambient intensity of the compositions was selected based on extensive piloting to be suitable for a standard bedroom sized room with an average of 10.5 m² and for night time use. Ambient perfume presentation into the room was provided via a Reed Diffuser device holding 7 rattan sticks (20% fragrance, 50 g fill volume). When screening volunteers, consideration was taken regarding the size of the bedroom, and whether the volunteer slept with their bedroom door and windows open or shut. For the non-fragranced diffuser (control), a mix of DPM and DPG was used. Participants were instructed to place the Reed Diffuser close to the bed (e.g. on a dresser/chest of drawers) but not on the bedside table (in case of accidents).

The study lasted two weeks for each participant. Each week, participants were provided with a fragrance Reed Diffuser, either containing fragrance test perfume composition, or the control liquid. Participants were informed that they would be testing two fragrance samples which, may vary in intensity, i.e. they were not explicitly informed that one of the diffusers did not contain a fragrance. During one week, participants slept in the presence of the control diffuser to measure baseline sleep quality (control week). In the other week participants slept in the presence of the perfume composition. The allocation of perfume and no-perfume conditions to week 1 and week 2 was counterbalanced across participants.

Information was supplied to the participants about how to use the reed Reed Diffuser. Participants were only required to setup the diffuser in the agreed position at the start of each week and exchange/remove the diffuser at the end of each week.

Each week, participants were provided with a set of 7 sleep diary questionnaires. Participants wore the actimeter each night as instructed. Each morning, 15 minutes after awakening, participants completed the sleep diary. The diary contained questions on sleep quality and quantity, as well as questions about awareness of the fragrance. On completion of the test at the end of the two weeks, participants were interviewed and debriefed about their experiences during the test.

Sleep diary measures were recorded by the 20 participants everyday using the sleep diary questionnaire. Sleep diary measures included those relating to sleep quality (sleep quality ratings, morning refreshed state ratings) and sleep quantity (sleep duration, estimated time to fall asleep, estimated number of wakenings). These measures are established sleep parameters and can be sensitive to differences in sleep performance.

Sleep quality ratings were recorded each day by the participants: Last Night I slept: Extremely well(=5) . . . Very well(=4) . . . Fairly well(=3) . . . Rather badly(=2) . . . Extremely badly(=1). Higher values were therefore associated with better sleep quality. The questionnaire results, averaged across each test week, showed participants reported that they slept significantly better in the presence of the fragrance compared to the non-fragranced control (p=0.002) (FIG. 1).

Participants also indicated on their sleep diaries relating to how refreshed they felt 15 minutes after waking: 15 minutes after waking I felt: Very refreshed(=5) . . . Refreshed(=4) . . . Neither(=3) . . . Tired(=2) . . . Very tired(=1). Higher values were therefore associated with participants feeling more refreshed first thing in the morning. The results, averaged across each test week, showed participants reported that they felt significantly more refreshed first thing in the morning after sleeping in the presence of the fragrance compared to the non-fragranced control (p=0.022) (FIG. 2).

Each day on the sleep diary, participants recorded the estimated time they thought it took them to fall asleep: For example, “As far as I remember it took me . . . minutes to fall asleep”. The results, averaged over each week, showed that participants perceived that they took significantly less time to fall asleep in the week when they were sleeping in the presence of a perfume composition compared to the non-fragranced control (p=0.043) (FIG. 3).

Participants also made a record of the estimated number of times they woke up during the night on their diary: For example “As far as I remember I woke up . . . times last night”. The results, averaged over each week, showed that participants perceived that they woke significantly less frequently when sleeping in the presence of the perfume composition compared to the non-fragranced control (p=0.02) (FIG. 4).

Average sleep duration was calculated according to the estimated time that participants thought they fell asleep (lights out-time taken to get to sleep) and the waking time in the morning. Durations were then averaged across each week. The results showed that self-reported sleep duration did not significantly differ between the perfume composition week (7 hours 29 mins) and the control week (7 hours 36 mins) (p=0.5).

A Philips Actiwatch® was used to monitor night-time sleep quality. The device was worn by the participants like a wristwatch and was small and lightweight. The Actiwatch® was strapped to the non-dominant wrist, each night and removed on awakening the next morning. A small ‘event marker’ button could be depressed by the participant to signify ‘going to sleep’ and ‘morning awakening’. The Actiwatch® logged body movements at 30 second intervals throughout sleep. The actigraphy module includes embodiments of any of the actigraphy devices manufactured by the following: ActiGraph LLC, ActiTrainer (was CSA/MTI), Ambulatory Monitoring Inc., Motionlogger Actigraph, Cambridge Neurotechnology Actiwatch, Consultoria Eletronica Four Parameter Brazilian Actigraph, Gulf Coast Data Concepts USB Accelerometer, MetriSense, Inc. —Distributor of activity monitors from CamNtech, Ltd., UK., PAL Technologies Ltd—Manufacturer of activity monitors, Philips Respironics Actiwatch.

Three parameters were analyzed from the Actiwatch® recordings: sleep efficiency (an overall measure of sleep quality), wake time (calculated from the total number of waking epochs during the night, including the time taken to fall asleep) and the percentage of time spent awake during the night relative to the time spent asleep. All three measures are based on validated software algorithms and are well-established measures used in sleep research.

Sleep efficiency scores were calculated using an in-built algorithm by the Actiware software. Efficiency scores were calculated for each night for each participant and compared across the two test weeks using ANOVA (factors of subject, condition, week, week day). The data demonstrated a strong trend for higher sleep efficiency scores when participants were sleeping in the presence of the ambient fragrance compared to the control week although this did not reach significance at the 95% level (p=0.080) (FIG. 5).

Two other parameters recorded by the Actiwatch® were wake time (in minutes) and the percentage of time awake during the night (relative to the percentage of time spent asleep). Scores for each parameter were calculated for each night and each participant and compared across the two test weeks using ANOVA. Analysis of wake time showed that participants sleeping in the presence of the ambient fragrance had a strong trend for reduced wake time during the night, compared to the control week. However again this did not reach significance at the 95% level (p=0.1) (FIG. 6).

This result was supported by analysis of the percentage of time spent awake relative to the percentage of time spent asleep. Statistical analysis of the percentage of the night spent awake compared to asleep, showed that participants spent less time awake during the nights in which they slept in the presence of the ambient fragrance compared to the non-fragranced control nights. However again this did not reach significance at the 95% level (p=0.078) (FIG. 7).

Further analysis was conducted to determine whether there was accurate alignment between objective measures in sleep as recorded by the actimeter and the self-reported responses recorded in the daily sleep diary (fragrance and non-fragranced data combined together).

Correlation analysis was conducted between sleep quality ratings as reported in the daily sleep diary and objective parameters recorded by the actimeters. The results showed that there was a significant correlation between self-reported levels of sleep quality (diary) and sleep efficiency (actimeter) (p=0.005). Better sleep quality ratings from the diary were associated with higher sleep efficiency scores (FIG. 8). This suggests that there was a good alignment between the sleep quality scores that participants reported on their daily sleep diary and the objective measures of sleep quality monitored by the actimeters.

Similarly, correlation analysis was conducted between refreshed after waking ratings as reported in the daily sleep diary and objective parameters recorded by the actimeter. Visual inspection of the results suggested an approximate alignment between how refreshed participants felt after waking (diary) and sleep efficiency scores (actimeter) although this was not significant (p=N/S; FIG. 9). This suggests that this refreshed after waking score was not as effective as the sleep quality scores in terms of alignment with the actimeter data.

Hereinafter, the present invention will be described in further detail with reference to examples, drawings and test examples. It is to be understood, however, that these examples are for illustrative purposes only and are not to be construed to limit the scope of the present invention.

FIG. 1-9 are a series of graphs, as follows:

FIG. 1: Sleep Quality ratings for the fragrance week compared to the non-fragranced control week.

FIG. 2: Refreshed after waking ratings for the fragrance week compared to the non-fragranced control week.

FIG. 3: Comparison of the estimated time taken to fall asleep in minutes for the fragrance week compared to the non-fragranced control week.

FIG. 4: Comparison of the average number of wakings during the night for the fragrance week compared to the non-fragranced control week.

FIG. 5: Sleep efficiency scores calculated from the actimeter recordings during the fragrance week compared to the non-fragranced control week.

FIG. 6: Wake time scores (includes time taken to fall asleep) calculated from the actimeter recordings during the fragrance week compared to the non-fragranced control week.

FIG. 7: Percentage of time awake calculated from the Actimeter recordings during the fragrance week compared to the non-fragranced control week.

FIG. 8: Relationship between actimeter sleep efficiency scores and self-reported ratings of sleep quality from the daily sleep diary. There were no sleep diary responses for “Extremely badly”

FIG. 9: Relationship between actimeter sleep efficiency scores and self-reported ratings from the daily sleep diary of how refreshed after waking participants felt.

FIG. 10 is a schematic representation of the task design. The task was made up of 10 mental maths tasks (heavy dotted borders) and 10 relaxation tasks (light dotted borders). Odours were presented during the relaxation tasks while EEG was recorded. Questionnaire rates were collected at the end of each relaxation

### EXAMPLES

The fragrance composition detailed in Table 1 were prepared and subjected to a variety of test protocols. Those fragrances labelled Fragrance 41 (=Example-Fragrance 4) and Fragrance 47 (=Example-Fragrance 6) are fragrance compositions according to the invention, whereas those labelled Fragrance 44 (Example-Fragrance 1) and Fragrance 37 are comparative examples not meeting the conditions of the present invention, which do not violate the guideline values for specific odour families have been highlighted.

TABLE 1
The range (minimum and maximum) values of test fragrances
compared against the range values of the ‘Sleep Good’
Fragrances. Cells with numbers in bold italics indicate a violation
of the recommended ranges. The final row details the outcome
(Yes or No) for recommendation, i.e. whether a test fragrance is
considered to have sleep-enhancing properties or not.

| | SLEEP GOOD | | TEST FRAGRANCES | | | |
|---|---|---|---|---|---|---|
| Family | MIN | MAX | Fragrance 41 | Fragrance 47 | Fragrance 44 | Fragrance 37 |
| ALDEHYDIC | 0.000 | 1.408 | 0.042 | 0.221 | [symbol] | 0.000 |
| ANISEED/ANISIC | 0.000 | 0.156 | 0.000 | 0.000 | 0.000 | [symbol] |
| CAMPHORACEOUS/AROMATIC | 0.000 | 8.212 | 0.000 | 0.000 | 2.021 | 2.200 |
| CITRUS | 1.200 | 28.873 | 10.938 | 1.905 | [symbol] | [symbol] |
| GREEN | 0.041 | 4.271 | 4.271 | 3.087 | [symbol] | [symbol] |
| HERBAL | 0.000 | 0.100 | 0.000 | 0.000 | [symbol] | [symbol] |
| MARINE/WATERY | 0.000 | 4.250 | 3.396 | 2.346 | 0.566 | 0.000 |
| MINT | 0.000 | 0.469 | 0.000 | 0.000 | 0.202 | [symbol] |
| SULPHUROUS | 0.000 | 0.208 | 0.208 | 0.060 | [symbol] | 0.000 |
| FLORAL | 32.172 | 79.310 | 63.542 | 59.944 | [symbol] | [symbol] |
| ORRIS | 0.000 | 10.024 | 2.083 | 10.024 | 0.889 | 0.000 |
| FRUITY | 0.000 | 21.071 | 12.604 | 21.071 | 12.164 | 0.000 |
| SPICY | 0.000 | 0.441 | 0.000 | 0.441 | 0.121 | 0.000 |
| AMBER | 0.000 | 22.482 | 2.083 | 0.000 | 1.313 | 0.000 |
| ANIMALIC/LEATHER | 0.000 | 1.408 | 0.042 | 0.000 | 0.000 | 0.000 |
| BALSAMIC | 0.000 | 0.122 | 0.000 | 0.000 | 0.000 | 0.000 |
| GOURMAND | 0.000 | 0.860 | 0.000 | 0.200 | 0.202 | 0.130 |
| MEDICINAL | 0.000 | 0.000 | 0.000 | 0.000 | 0.000 | 0.000 |
| MUSK | 0.000 | 44.426 | 0.000 | 0.000 | 1.010 | 0.200 |
| SWEET/POWDERY | 0.200 | 7.821 | 0.271 | 0.200 | 0.404 | 0.030 |
| WOODY/PINE | 0.000 | 10.363 | 0.521 | 0.501 | 5.052 | 0.000 |
| FUNGAL | 0.000 | 0.002 | 0.000 | 0.000 | 0.000 | 0.000 |
| ORAL CARE | 0.000 | 0.000 | 0.000 | 0.000 | 0.000 | [symbol] |
| | | OUTCOME | YES | YES | NO | NO |

Example-Fragrance-1 will be compared with fragrances Example-Fragrance-2, Example-Fragrance-3, Example-Fragrance-4, Example-Fragrance-5, Example-Fragrance-6, and Example-Fragrance-7.

The fragrances, as measured through EEG in a previously outlined paradigm and a validation test, produced the following results:

TABLE 2
Sandman classifier and validation measure values of test fragrances
Validation measure = Sleep % + (Sleep Quality)2

| | Sandman | Validation |
|---|---|---|
| Fragrance | classifier | measure |
| Example-Fragrance-1 | 1.080 | 106.350 |
| Example-Fragrance-2 | 2.456 | 108.093 |
| Example-Fragrance-3 | 2.691 | 107.856 |
| Example-Fragrance-4 | 2.484 | 109.121 |
| Example-Fragrance-5 | 1.361 | 107.186 |
| Example-Fragrance-6 | 3.033 | 107.266 |
| Example-Fragrance-7 | 2.312 | 107.632 |

Sleep % is a measure taken from the algorithm in actigraphy and is an overall measure of sleep quality, while Sleep Quality is a subjective measure that takes values 1 to 5.

By directly comparing the Sandman classifier value of Example-Fragrance-1 vs. the equivalent values of any of Example-Fragrance-2, Example-Fragrance-3, Example-Fragrance-4, Example-Fragrance-5, Example-Fragrance-6, or Example-Fragrance-7, we see that Example-Fragrance-1 has a lower Sandman classifier value than any of the other fragrances. In addition, the Sandman classifier value of Example-Fragrance-1 is below the specified threshold of 1.35. We can therefore predict that Example-Fragrance-1 will be considerably less sleep-enhancing than any of the other fragrances. Indeed, our validation measure shows exactly this.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A method of preparing a perfume composition adapted to address sleep quality, said method comprising the steps of:
measuring the brain wave activity of a human subject after inhaling said perfume composition by electroencephalography (EEG) using the standard 10-20 electrode system;
determining the Sandman Classifier (SC) according to the following formula
SC=((a1_{ce}+Θ_{ce})/δₜₑₘ)+(Θ/a2)
wherein:
a1_{ce} represents the amplitude value of alpha-1 brain wave activity with a frequency of oscillation between 8-12 hertz over the central electrodes C3, C4, Cz
Θ_{ce} represents the amplitude value of theta brain wave activity with a frequency of oscillation between 4-7 Hertz over the central electrodes C3, C4, Cz
δₜₑₘ represents the amplitude value of theta brain wave activity with a frequency of oscillation between 0.1-3 Hz over the temporal electrodes T7 and T8; and
Θ/a2 represents the ratio of the amplitude of theta brain wave activity with a frequency of oscillation between 4-7 Hertz over the amplitude value of alpha-2 brain wave with a frequency of oscillation between 12-15 hertz, across all electrodes;
and
combining functional perfume ingredients in a manner such that said combination has a Sandman Classifier value greater than 1.35.

14. The method of preparing a perfume composition according to claim 13, wherein the perfume composition comprises at least 2, more particularly at least 5, still more particularly 10 or more perfume ingredients, having a known Sandman Classifier (SC) value of at least 1.35.

15. The method of preparing a perfume composition according to claim 13, wherein the perfume composition comprises at least 0.01% by weight of perfume materials drawn from the following groups:
A) about 1 wt % to about 30 wt %, more particular about 1.2 wt % to 28.9 wt %, based on the total amount of perfumery ingredients used in the perfume composition, of at least one citrus ingredient, in particular a citrus ingredient selected from the group consisting of: Bergamot oils, essences, extracts, bases, substitutes or replacers, such as BERGAMOT OIL ITALY EXPRESSED; BERGAMOT REC ABX5638; BERGAMOTE GIVCO 104/4; CITRAL LEMAROME N; CITRAL TECH; CITRATHAL R; CITRONELLYL NITRILE; CLONAL; CYMENE PARA; DIHYDRO MYRCENOL; DIMETHYL OCTENONE; DIMETOL; FLOROPAL; Grapefruit oils, essences, extracts, replacers or substitutes, such as GRAPEFRUIT JUICE SUPER CONC 7108A or GRAPEFRUIT OIL COSMOS; lemon oils, essences, extracts, bases, substitutes or replacers, such as LEMON OIL CALIFORNIA TYPE DISTLD PURE; LEMON OIL ITALIAN ORPUR COSMOS; LEMON OIL RECONSTITUTION 1385; LEMON SPANISH DQ (AC) XN 41482TT; LEMONILE; LINALOOL OXIDE; LINALYL ACETATE SYNTHETIC; Litsea Cubeba oils, essences, extracts, replacers or substitutes, such as LITSEA CUBEBA OIL CHINA; mandarin oils, essences, extracts, bases, substitutes or replacers, such as MANDARIN ARTESSENCE OIL; MANDARIN OIL GREEN BRAZIL ORPUR; MANDARIN OIL ITALY COLOURLESS MD ORPUR; MANDARIN OIL WASHED COSMOS; MANDARINAL 32048 SAE; MANDARINAL 32048 SAE/2; MANDARINAL MATCH CF; METHYL PAMPLEMOUSSE; MYRCENE 90; orange oils, essences, extracts, bases, substitutes or replacers, such as ORANGE 49; ORANGE ALDEHYDE; ORANGE CALIFORNIAN DQ (AC) XN 41228TT; ORANGE OIL BRAZIL; ORANGE OIL COLORLESS N.S.; ORANGE OIL FLORIDA; ORANGE SAVON CONC OIL; ORANGE TERPENELESS DQ (AC) 41483TT; ORANGE TERPENES DISTILLED; petitgrain oils, essences, extracts, bases, replacers or substitutes, such as PETITGRAIN CITRONNIER OIL ORPUR; PRECYCLEMONE B; PRENYL ACETATE; RHUBAFURAN; Tamarine oils, essences, extracts, bases, replacers or substitutes, such as TAMARINE AB 8212; tangerine oils, essences, extracts, essence, bases, replacers or substitutes, such as TANGERINE SOUTH AFRICAN DQ AC XN 41957TT; TERPINENE GAMMA; TERPINOLENE; and TERPINYL ACETATE;
and at least one ingredient from at least five of the groups B1 through B20 in the amounts indicated:
B1) about 0.01 wt % to about 1.5 wt %, more particularly about 0.01 wt % to about 1.41 wt % based on the perfumery ingredients used in the perfume composition, of at least one aldehydic ingredient selected from the group consisting of: ALDEHYDE C 10 DECYLIC; ALDEHYDE C 11 UNDECYLENIC; ALDEHYDE C 110 UNDECYLIC; ALDEHYDE C 12 LAURIC; ALDEHYDE C 12 MNA PURE; ALDEHYDE C 8 OCTYLIC FOOD GRADE; ALDEHYDE C 9 ISONONYLIC; ALDEHYDE C 9 NONYLIC FOOD GRADE; ALDEHYDE C 90 NONENYLIC 1%/TEC; ALDEHYDE C12 (DODECANAL); ALDEHYDE ISO C 11; mandarine aldehydes, such as ALDEHYDE MANDARINE 10%/TEC; trans-4-decenal, such as DECENAL-4-TRANS, DECENAL-4-TRANS 10%/TEC; DIHYDROFARNESAL; dodecanal, such as DODECENAL 10%/TEC; MYRALDENE; and TANGERINOL;
B2) about 0.01 wt % to about 25 wt %, more particularly about 0.01 wt % to about 22.49 wt %, based on the perfumery ingredients used in the perfume composition, of at least one amber ingredient selected from the group consisting of: Amberketal, such as AMBERKETAL 1%/TEC; AMBERKETAL IPM; Ambermax, such as AMBERMAX 10%/TEC, AMBERMAX 50%/DOWANOL TPM; Ambrocenide, such as AMBROCENIDE 10%/DPG; AMBROFIX; AMBROFIX FLAKES; Belambre, such as BELAMBRE 50%/IPM; BOISAMBRENE FORTE; CEDRYL ACETATE LIQUID; CEDRYL METHYL ETHER; CETALOX; ISO E SUPER; KARANAL; KEPHALIS; TIMBEROL; TRIMOFIX O;
B3) about 0.01 wt % to about 1.5 wt %, more particularly about 0.01 wt % to about 1.41 wt % based on the perfumery ingredients used in the perfume composition, of at least one animalic/leather ingredient selected from the group consisting of: ANIMALIS 1745 SUBST. PMF 2; cade oils, essences, extracts, replacers substitutes, such as CADE OIL SPAIN; GUAIACOL; INDOFLOR; Indole, such as INDOLE, INDOLE 1%/TEC; Indolene, such as INDOLENE 50%/CASTOR OIL; Suederal ingredients, such as SUEDERAL LT 0710;
B4) about 0.01 wt % to about 0.2 wt %, more particularly about 0.01 wt % to about 0.16 wt % based on the perfumery ingredients used in the perfume composition, of at least one anisic ingredient selected from the group consisting of: ANETHOLE; ANISE STAR OIL; ANISIC ALDEHYDE; ANISYL ACETATE; DIHYDRO ANETHOLE; ESTRAGOLE; fennel sweet oils, essences, extracts, bases, replacers or substitutes, such as FENNEL SWEET 50% DQ (AC) 24190TT; FENNEL SWEET DQ (AC) N 41632TT; FENNEL OIL SWEET; FENNEL OIL SWEET TECH;
B5) about 0.01 wt % to about 0.2 wt %, more particularly about 0.01 wt % to about 0.13 wt % based on the perfumery ingredients used in the perfume composition, of at least one balsamic ingredient selected from the group consisting of: Benzoin oils, essences, extracts, replacers or substitutes, such as BENZOIN SI GU ETA 50% BB AAF0515 41235EH; BENZYL ALCOHOL; BENZYL CINNAMATE; Olibanum oils, essences, extracts, replacers or substitutes, such as OLIBANUM COEUR DEP FREE 50%/TEC; OLIBANUM OIL SOMALIA ORPUR; PHENYL ETHYL PHENYL ACETATE;
B6) about 0.01 wt % to about 10 wt %, more particularly about 0.01 wt % to about 8.13 wt % based on the perfumery ingredients used in the perfume composition, of at least one camphoraceous/aromatic ingredient selected from the group consisting of: Armoise oils, essences, extracts, replacers or substitutes, such as ARMOISE OIL MOROCCO ORPUR COSMOS; Camphor and Camphor oils, essences, extracts, replacers or substitutes such as CAMPHOR; CAMPHOR OIL WHITE; Eucalyptol and Eucalyptol oils, essences, extracts, replacers or substitutes, such as EUCALYPTOL; EUCALYPTUS GLOBULUS OIL CHINA COSMOS; Lavandin oils, essences, extracts, replacers or substitutes, such as LAVANDIN BRIALIS DQ (AC) XN 41665TT; LAVANDIN GROSSO OIL FRANCE ORPUR; LAVANDIN RGV 4; Lavender oils, extracts, essences, replacers or substitutes, such as LAVENDER DQ (AC) XN 41569TT; Rosemary oils, essences, extracts, replacers or substitutes, such as ROSEMARY OIL; ROSEMARY OIL RECONST; Thuja oils, essences, extracts, replacers or substitutes, such as THUJA OIL KOREA;
B7) about 30 wt % to about 80 wt %, more particularly about 32 wt % to about 79 wt % based on the perfumery ingredients used in the perfume composition, of at least one floral ingredient selected from the group consisting of: ACETAL CD; AMYL CINNAMIC ALDEHYDE; AMYL SALICYLATE; AURANTIOL PURE BENZYL ACETATE; BENZYL SALICYLATE; BOURGEONAL; CITRONELLOL; CITRONELLYL ACETATE; CRESYL METHYL ETHER PARA; CYCLAMEN ALDEHYDE EXTRA; CYCLOHEXAL; CYCLOHEXYL SALICYLATE; DIMETHYL ANTHRANILATE; DIMETHYL PHENYL THYL CARBINOL; DUPICAL; ETHYL LINALOOL; FLOROSA; FLOROSA HC; GERANIOL; Geranium oils, essences, extracts, replacers or substitutes, such as GERANIUM 230/3 MOD; GERANIUM ABQ5629; GERANIUM BOURBON DQ (AC) XN 41563TT; GERANODYLE; GERANYL ACETATE; GERANYL BUTYRATE; HEDIONE; HEDIONE HC; HEXENYL-3-CIS SALICYLATE; HEXYL CINNAMIC ALDEHYDE; HEXYL CINNAMIC ALDEHYDE DQ AC XI 41505TT; HEXYL SALICYLATE; HYDROXYCITRONELLAL; ISOBUTYL PHENYL ACETATE; ISOBUTYL SALICYLATE; JASMATONE; Jasmin oils, essences, extracts, replacers or substitutes, such as JASMIN ABSOLUTE DQ (AC) 41568TT; JASMIN ARGENT 2; JASMONE CIS; JASMONYL; JASMOPYRANE FORTE; LILIAL and lilial substitutes; LINALOOL; MEFROSOL; METHYL ANTHRANILATE; METHYL ANTHRANILATE EXTRA; METHYL BENZOATE; METHYL PHENYL ACETATE; Neroli oils, essences, extracts, replacers or substitutes, such as NEROLI ESSENTIAL BASE AB 7632; NEROLI PHASE ESS; NEROLINE CRYSTALS; NEROLIONE; Orange oils, essences, extracts, replacers or substitutes, such as ORANGE FLOWER TEC AB 2169E; ORANGER CRYSTALS; ORANGER FLEUR CREME 1103/20; PELARGOL; PEONILE; PETALIA; PHENYL ETHYL ACETATE; PHENYL ETHYL ALCOHOL; PHENYL ETHYL ISOVALERATE; PHENYL ETHYL SALICYLATE CRYSTALS; ROSACETOL; ROSALVA; Rose oils, essences, extracts, replacers or substitutes, such as ROSE BASE ABF0339A-K182572; ROSE TW 62/10/20; SUPER MUGUET; TERPINEOL PURE; TETRAHYDRO LINALOOL; VERDANTIOL; YARA YARA; Ylang oils, essences, extracts, replacers or substitutes, such as YLANG AB 0388A; YLANG ECO ESSENCE;
B8) about 0.01 wt % to about 22 wt %, more particularly about 0.01 wt % to about 21.08 wt % based on the perfumery ingredients used in the perfume composition, of at least one fruity ingredient selected from the group consisting of: ACETATE C 6 HEXYLIC; AGRUMEX; ALLYL AMYL GLYCOLATE; ALLYL CAPROATE; ALLYL CYCLOHEXYL PROPIONATE; ALLYL OENANTHATE; AMYL BUTYRATE; APHERMATE; Apple oils, essences, extracts, replacers or substitutes, such as APPLE BASE ABF1016-K108004; Banana oils, essences, extracts, replacers or substitutes, such as BANANA BASE ABF0961A-K108784; BENZYL BUTYRATE; BENZYL ISOBUTYRATE; BENZYL PROPIONATE; BUTYL ACETATE; BUTYRIC ACID; Cassis oils, essences, extracts, replacers or substitutes, such as CASSIS BASE 345-F CS/4/20; CASSIS BASE 345B RECO TEC AB 8408D; COGNAC WHITE OIL EXTRA DQ (AC) 41547TT; CYCLOGALBANATE; DAMASCENONE; DAMASCONE ALPHA; DAMASCONE BETA; DAMASCONE DELTA; DECALACTONE DELTA; DECALACTONE GAMMA; Dewfruit oils, essences, extracts, replacers or substitutes, such as DEWFRUIT/2; DEWFRUIT TEC AB 2927R LILIAL FREE; DIETHYL MALONATE; DIMETHYL BENZYL CARBINYL ACETATE; DIMETHYL BENZYL CARBINYL BUTYRATE; DODECALACTONE DELTA; DODECALACTONE GAMMA; ETHYL ACETOACETATE; ETHYL BUTYRATE; ETHYL CAPROATE; ETHYL CAPRYLATE; ETHYL ISOAMYL KETONE; ETHYL ISOBUTYRATE; ETHYL METHYL-2-BUTYRATE; ETHYL OENANTHATE; ETHYL PELARGONATE; ETHYL PROPIONATE; ETHYL SAFRANATE; FLOROCYCLENE; FRAISTONE; FRUCTONE; FRUITATE; GARDOCYCLENE; GIVESCONE; Guave oils, essences, extracts, replacers or substitutes, such as GUAVE DUPLICATION/2; HEXENYL-3-CIS BUTYRATE; HEXENYL-3-CIS ISOBUTYRATE; HEXYL BUTYRATE; HEXYL ISOBUTYRATE; ISOAMYL ACETATE EXTRA; ISOAMYL BUTYRATE FR; JASMACYCLENE; MANZANATE; Melon oils, essences, extracts, replacers or substitutes, such as MELON HONEYDEW/2; METHOXY PHENYL BUTANONE; METHYL HEPTENONE PURE; METHYL HEXYL KETONE; METHYL-2-PENTENOIC ACID; 2-NECTARYL; OCTALACTONE GAMMA; PEACH PURE; PHENOXY ETHYL ISOBUTYRATE; PHENYL ETHYL ISOBUTYRATE; PRUNOLIDE; RASPBERRY KETONE (N112); STRAWBERRY PURE;
B9) about 0.001 wt % to about 0.01 wt %, more particularly about 0.001 wt % to about 0.002 wt % based on the perfumery ingredients used in the perfume composition, of at least one fungal ingredient selected from the group consisting of: AMYL VINYL CARBINOL; OCIMENE
B10) about 0.01 wt % to about 1 wt %, more particularly about 0.01 wt % to about 0.86 wt % based on the perfumery ingredients used in the perfume composition, of at least one gourmand ingredient selected from the group consisting of: ACETOIN; Acetyl pyrazine, such as ACETYL PYRAZINE 1%/TEC; BENZALDEHYDE; BUTYL BUTYRO LACTATE; Chocolate oils, essences, extracts, replacers or substitutes, such as CHOCOLAT NOIR 1130 TEC/3; CORYLONE DRIED; CYCLOTENE; Ethyl maltol, such as ETHYL MALTOL; ETHYL MALTOL 1%/BA; Homofuronol, such as HOMOFURONOL 20%/TEC; Hydroxy ethyl methyl thiazol, such as HYDROXY ETHYL METHYL THIAZOL 10%/TEC; ISOBUTAVAN; MALTYL ISOBUTYRATE;
B11) about 0.01 wt % to about 5 wt %, more particularly 0.041 wt % to about 4.28 wt % based on the perfumery ingredients used in the perfume composition, of at least one green ingredient selected from the group consisting of: ACETAL E; ALCOHOL C 6 HEXYLIC; ALDEHYDE C 6 HEXYLIC FOOD GRADE; BUTYL QUINOLINE SECONDARY; CYCLAL C; DIPHENYL OXIDE; ELINTAAL; ETHYL DECADIENOATE; ETHYL DIMETHYL Pyrazine, such as PYRAZINE 1%/TEC; Galbanone, such as GALBANONE 10; GALBANONE PURE; GARDENOL; Hexenal-2-trans, such as HEXENAL-2-TRANS 10%/TEC; HEXENOL-2-TRANS; HEXENOL-3-CIS; HEXENYL-3-CIS ACETATE; HEXENYL-3-CIS BENZOATE; HEXENYL-3-CIS PROPIONATE; ISOCYCLOCITRAL; Isohexylmethoxy pyrazine, such as ISOHEXYLMETHOXY PYRAZINE 1%/TEC; LIFFAROME; LIGANTRAAL; MACEAL; METHYL OCTYNE CARBONATE; NEOFOLIONE; Nonadienal, such as NONADIENAL; NONADIENAL 1%/TEC; NONADIENOL-2,6; Nonenal-6-cis, such NONENAL-6-CIS 10%/TEC; NONENOL-6-CIS; Petitgrain oils, essences, extracts, replacers or substitutes, such as PETITGRAIN ECO ESSENCE; PETITGRAIN OIL PARAGUAY; Phenoxyacetaldehyde, such as PHENOXY ACETALDEHYDE 50; Phenyl acetaldehyde, such as PHENYL ACETALDEHYDE 50%/PHENYL ETHYL ALC; PYRALONE; RESEDAL; ROSE OXIDE; ROSYRANE SUPER; STEMONE; TRICYCLAL; TRIFERNAL; UNDECATRIENE; UNDECAVERTOL; Violet nitrile, such as VIOLET NITRILE 0.1%/TEC; VIOLET NITRILE 10%/TEC; VIRIDINE;
B12) about 0.01 wt % to about 0.5 wt %, more particularly 0.01 wt % to about 0.1 wt % based on the perfumery ingredients used in the perfume composition, of at least one herbal ingredient selected from the group consisting of: Basil oils, essences, extracts, replacers or substitutes, such as BASIL OIL EGYPT ORPUR; Camomile oils, essences, extracts, replacers or substitutes, such as CAMOMILE ENGLISH DQ (AC) XN 41528TT; CITRONELLAL; Clary sage oils, essences, extracts, replacers or substitutes, such as CLARY SAGE OIL COSMOS; CLARY SAGE OIL FRANCE ORPUR; CYPRISATE; Eucalyptus oils, extracts, essences, replacers or substitutes, such as EUCALYPTUS CITRIODORA OIL BRAZIL; HERBOXANE; PINOACETALDEHYDE; TANAISONE; Thyme oils, essences, extracts, replacers or substitutes, such as THYME OIL RED 40-45%; THYME WHITE DQ (AC) XN 41491TT; THYMOL CRYSTALS;
B13) about 0.01 wt % to about 5 wt %, more particularly about 0.01 wt % to about 4.3 wt % based on the perfumery ingredients used in the perfume composition, of at least one marine/watery ingredient selected from the group consisting of: ADOXAL; Azurone, such as AZURONE 10%/TEC; CALONE 1951; FENNALDEHYDE; FLORALOZONE; FLORHYDRAL; MELONAL; SCENTENAL; TROPIONAL; VERNALDEHYDE;
B14) about 0.01 wt % to about 0.5 wt %, more particularly about 0.01 wt % to about 0.47 wt % based on the perfumery ingredients used in the perfume composition, of at least one mint ingredient selected from the group consisting of: Buchu leaf oils, essences, extracts, replacers or substitutes, such as BUCHU LEAF OIL SOUTH AFRICA COSMOS; CARVONE LAEVO; Cornmint oils, essences, extracts, replacers or substitutes, such as CORNMINT OIL DEMENTHOLIZED; FRESKOMENTHE; ISOMENTHONE DL; MENTHOL LAEVO; MENTHOL-DL; MENTHONE; MENTHYL ACETATE; Peppermint oils, essences, extracts, replacers or substitutes, such as PEPPERMINT AM FAR WEST DQ AC 41624TT; PEPPERMINT AM MID WEST MIW DQ AC 41253TT; PEPPERMINT AM WILL REDIST DQ AC 24150TT; PEPPERMINT AM WILLAM NAT DQ AC 37968TT; PEPPERMINT AMER 9303 DQ (AC) 37934TT; PEPPERMINT CHINESE T'LES(EXCN)DQ 24329TT; PEPPERMINT CHINESE TR (CN) DQ 24109TT; PEPPERMINT CN TERPLESS FDC DQ AC 37921TT; PEPPERMINT HMF DQ 24817TT; PEPPERMINT INDIAN TPC-1 DQ AC 24049TT; PEPPERMINT OIL BLEND; PEPPERMINT PIP IND REC.FDC DQ AC 24040TT; Spearmint oils, essences, extracts, replacers or substitutes, such as SPEARMINT AM FW NAT DQ AC XN 41610TT; SPEARMINT OIL USA TYPE;
B15) about 0.01 wt % to about 50 wt %, more particularly about 0.01 wt % to about 44.43 wt % based on the perfumery ingredients used in the perfume composition, of at least one musk ingredient selected from the group consisting of: AMBRETTOLIDE; CASHMERAN; COSMONE; Cyclopentadecanolide, such as CYCLO PENTA DECANOLIDE DQ 1% PG; ETHYLENE BRASSYLATE; GALAXOLIDE; GALAXOLIDE S; HABANOLIDE; MUSCENONE; MUSK C14; SERENOLIDE; SILVANONE SUPRA; SYLKOLIDE; VELVIONE;
B16) about 0.01 wt % to about 10 wt % based on the perfumery ingredients used in the perfume composition, of at least one orris ingredient selected from the group consisting of: CETONE V; DIHYDRO IONONE BETA; IONONE BETA; IRISONE ALPHA; IRISONE PURE; ISORALDEINE 70; ISORALDEINE 95; ORIVONE;
B17) about 0.01 wt % to about 1 wt %, more particularly about 0.01 wt % to about 0.45 wt % based on the perfumery ingredients used in the perfume composition, of at least one spicy ingredient selected from the group consisting of: Cardamom oils, essences, extracts, replacers or substitutes, such as CARDAMOM SEED OIL ORPUR; CARDAMOM SUBSTITUTE 1527 F; CARDAMOME SUBSTITUT 1527 F/2; CARYOPHYLLENE; CINNAMIC ALCOHOL CINNAMIC ALCOHOL; CINNAMIC ALDEHYDE; Cinnamon leaf oils, essences, extracts, replacers or substitutes, such as CINNAMON LEAF OIL WASHED ORPUR; Clove oils, essences, extracts, replacers or substitutes, such as CLOVE BUD OIL; CLOVE LEAF OIL COLORLESS; CLOVE LEAF OIL RECTIFIED RB COSMOS; Coriander oils, essences, extracts, replacers or substitutes, such as CORIANDER SEEDS OIL ORPUR COSMOS; Elemi oils, essences, extracts, replacers or substitutes, such as ELEMI RESINOID 50%/BB; ETHYL CINNAMATE; EUGENOL; Ginger oils, essences, extracts, replacers or substitutes, such as GINGER OIL INDIA ORPUR; GINGER ROOT FRESH CUT; ISOEUGENOL; IMETHYL CINNAMATE; METHYL ISOEUGENOL; MYSTIKAL; Nutmeg oils, essences, extracts, replacers or substitutes, such as NUTMEG OIL INDONESIA; Pepper oils, essences, extracts, replacers or substitutes, such as PEPPER BLACK OIL MADAGASCAR ORPUR; SZECHUAN PEPPER (ASH BARK) DQ AF 24070TT;
B18) about 0.01 wt % to about 0.5 wt %, more particularly about 0.01 wt % to about 0.21 wt % based on the perfumery ingredients used in the perfume composition, of at least one sulphurous ingredient selected from the group consisting of: Anjeruk, such as ANJERUK 0.01%/TEC; Corps cassis, such as CORPS CASSIS 0.1%/TEC; CORPS CASSIS 10%/TEC; Corps pamplemousse, such as CORPS PAMPLEMOUSSE PURE 1%/TEC; CORPS PAMPLEMOUSSE PURE 10%/TEC; Dimethyl sulphide, such as DIMETHYL SULFIDE; DIMETHYL SULFIDE 1%/TEC; GARDAMIDE; Labienoxime, such as LABIENOXIME 1%/IPM-TEC; Mercaptans, such as MERCAPTO-8 MENTHENE-1 PARA 0.1% IN TEC; METHYL ISOPROPYL THIAZOLE; Nardozeste oils, essences, extracts, replacers or substitutes, such as NARDOZESTE ABQ5031; NEOCASPIRENE EXTRA; NONIVAMIDE 1% TRIACETIN; Oxane, such as OXANE 50%/TEC; PARADISAMIDE; Paramenthone, such as PARAMENTHONE 1%/TEC;
B19) about 0.01 wt % to about 10 wt %, more particularly about 0.2 wt % to about 7.83 wt % based on the perfumery ingredients used in the perfume composition, of at least one sweet/powdery ingredient selected from the group consisting of: ACETOPHENONE; AUBEPINE PARA CRESOL; BICYCLO NONALACTONE; COUMARIN; Ethyl laitone, such as ETHYL LAITONE 1%/TEC; ETHYL VANILLIN; HELIOTROPIN Vanilla oils, essences, extracts, replacers or substitutes, such as VANILLA ABSOLUTE 20 FOLD DQ AC 41493TT; VANILLA S/ABS DEC 50% PG AAF0517 L228655; VANILLA SUP ABS DEC DQ P17 SB AC 41561TT; VANILLAL DQ (AF) 41319TT; VANILLIN; VANILLIN DQ (AF) 41320TT; Vanolia oils, essences, extracts, replacers or substitutes, such as VANOLIA BASE ABF0303B; VERATRIC ALDEHYDE;
B20) about 0.01 wt % to about 15 wt %, more particularly about 0.01 wt % to about 10.37 wt % based on the perfumery ingredients used in the perfume composition, of at least one woody/pine ingredient selected from the group consisting of: BORNEOL; BORNYL ACETATE LIQUID; BUTYL CYCLOHEXANOL PARA; BUTYL CYCLOHEXYL ACETATE PARA; Cedar wood oils, essences, extracts, replacers or substitutes, such as CEDARWOOD OIL USA VIRGINIA TYPE ORPUR; CONIFERAN; EBANOL; EVERNYL; FENCHYL ACETATE; Guaiac wood oils, essences, extracts, replacers or substitutes, such as GUAIACWOOD OIL PARAGUAY; ISONONANYL ACETATE; JAVANOL; KOHINOOL; MENTHANYL ACETATE; METHYL CEDRYL KETONE; NOPYL ACETATE; OSYROL; OXYOCTALINE FORMATE; Patchouli oils, essences, extracts, replacers or substitutes, such as PATCHOULI OIL COLORLESS INDONESIA; PATCHOULI OIL IRONFREE INDONESIA COSMOS; PINENE ALPHA; PINENE BETA; RADJANOL; RADJANOL SUPER; Turpentine oils, essences, extracts, replacers or substitutes, such as TURPENTINE OIL RECTIFIED; VERTOFIX COEUR; Vetiver oils, essences, extracts, replacers or substitutes, such as VETIVER OIL HAITI ORPUR ORGANIC COSMOS;
and optionally
B21) about 0.01 wt % to about 10 wt % based on the perfumery ingredients used in the perfume composition, of at least one ingredient selected from the group consisting of: ALDEHYDE C12 (DODECANAL); and MENTHYL ACETATE.

16. A method of preparing a consumer product, comprising the step of incorporating into a consumer product base a perfume composition having a known Sandman Classifier value greater than 1.35, wherein the perfume composition is prepared according to the method of claim 1.

17. The method of preparing a consumer product according to claim 16, wherein the consumer product is selected from the group consisting of a laundry care product, a personal care product, an oral care product, an air care product or a home care product.

18. The method of preparing a consumer product according to claim 17, wherein the consumer product is:
an air-freshener product comprising 0.01% to 25% by weight of the perfume composition; or,
an oral care product comprising 0.01% to 60% by weight of the perfume composition; or,
a fabric care product comprising 0.01% to 20% by weight of the perfume composition; or,
a personal care product comprising 0.01% to 20% by weight of the perfume composition; or,
a home care product comprising 0.01% to 34% by weight of the perfume composition is prepared.

19. A method of providing improved sleep quality through the inhalation of an effective amount of a perfume composition prepared according to the method of claim 1.

20. A method of determining the Sandman Classifier (SC) of a perfume composition, comprising the steps of:
measuring the brain wave activity of a human subject after inhaling said perfume composition by electroencephalography (EEG) using the standard 10-20 electrode system; and
determining the Sandman Classifier (SC) according to the following formula
SC=((a1_{ce}+Θ_{ce})/δₜₑₘ)+(Θ/a2)
wherein:
a1_{ce} represents the amplitude value of alpha-1 brain wave activity with a frequency of oscillation between 8-12 hertz over the central electrodes C3, C4, Cz
Θ_{ce} represents the amplitude value of theta brain wave activity with a frequency of oscillation between 4-7 Hertz over the central electrodes C3, C4, Cz
δₜₑₘ represents the amplitude value of theta brain wave activity with a frequency of oscillation between 0.1-3 Hz over the temporal electrodes T7 and T8; and
Θ/a2 represents the ratio of the amplitude of theta brain wave activity with a frequency of oscillation between 4-7 Hertz over the amplitude value of alpha-2 brain wave with a frequency of oscillation between 12-15 hertz, across all electrodes.

21. A perfume composition comprising at least 2, more particularly at least 5, still more particularly 10 or more perfume ingredients, having a known Sandman Classifier (SC) value of at least 1.35.

22. The perfume composition of claim 21, comprising wherein the perfume composition comprises at least 0.01% by weight of perfume materials drawn from the following groups:
A) about 1 wt % to about 30 wt %, more particular about 1.2 wt % to 28.9 wt %, based on the total amount of perfumery ingredients used in the perfume composition, of at least one citrus ingredient, in particular a citrus ingredient selected from the group consisting of: Bergamot oils, essences, extracts, bases, substitutes or replacers, such as BERGAMOT OIL ITALY EXPRESSED; BERGAMOT REC ABX5638; BERGAMOTE GIVCO 104/4; CITRAL LEMAROME N; CITRAL TECH; CITRATHAL R; CITRONELLYL NITRILE; CLONAL; CYMENE PARA; DIHYDRO MYRCENOL; DIMETHYL OCTENONE; DIMETOL; FLOROPAL; Grapefruit oils, essences, extracts, replacers or substitutes, such as GRAPEFRUIT JUICE SUPER CONC 7108A or GRAPEFRUIT OIL COSMOS; lemon oils, essences, extracts, bases, substitutes or replacers, such as LEMON OIL CALIFORNIA TYPE DISTLD PURE; LEMON OIL ITALIAN ORPUR COSMOS; LEMON OIL RECONSTITUTION 1385; LEMON SPANISH DQ (AC) XN 41482TT; LEMONILE; LINALOOL OXIDE; LINALYL ACETATE SYNTHETIC; Litsea Cubeba oils, essences, extracts, replacers or substitutes, such as LITSEA CUBEBA OIL CHINA; mandarin oils, essences, extracts, bases, substitutes or replacers, such as MANDARIN ARTESSENCE OIL; MANDARIN OIL GREEN BRAZIL ORPUR; MANDARIN OIL ITALY COLOURLESS MD ORPUR; MANDARIN OIL WASHED COSMOS; MANDARINAL 32048 SAE; MANDARINAL 32048 SAE/2; MANDARINAL MATCH CF; METHYL PAMPLEMOUSSE; MYRCENE 90; orange oils, essences, extracts, bases, substitutes or replacers, such as ORANGE 49; ORANGE ALDEHYDE; ORANGE CALIFORNIAN DQ (AC) XN 41228TT; ORANGE OIL BRAZIL; ORANGE OIL COLORLESS N.S.; ORANGE OIL FLORIDA; ORANGE SAVON CONC OIL; ORANGE TERPENELESS DQ (AC) 41483TT; ORANGE TERPENES DISTILLED; petitgrain oils, essences, extracts, bases, replacers or substitutes, such as PETITGRAIN CITRONNIER OIL ORPUR; PRECYCLEMONE B; PRENYL ACETATE; RHUBAFURAN; Tamarine oils, essences, extracts, bases, replacers or substitutes, such as TAMARINE AB 8212; tangerine oils, essences, extracts, essence, bases, replacers or substitutes, such as TANGERINE SOUTH AFRICAN DQ AC XN 41957TT; TERPINENE GAMMA; TERPINOLENE; and TERPINYL ACETATE;
at least one ingredient from group B7 in the amounts indicated:
B7) about 30 wt % to about 80 wt %, more particularly about 32 wt % to about 79 wt % based on the perfumery ingredients used in the perfume composition, of at least one floral ingredient selected from the group consisting of: ACETAL CD; AMYL CINNAMIC ALDEHYDE; AMYL SALICYLATE; AURANTIOL PURE BENZYL ACETATE; BENZYL SALICYLATE; BOURGEONAL; CITRONELLOL; CITRONELLYL ACETATE; CRESYL METHYL ETHER PARA; CYCLAMEN ALDEHYDE EXTRA; CYCLOHEXAL; CYCLOHEXYL SALICYLATE; DIMETHYL ANTHRANILATE; DIMETHYL PHENYL THYL CARBINOL; DUPICAL; ETHYL LINALOOL; FLOROSA; FLOROSA HC; GERANIOL; Geranium oils, essences, extracts, replacers or substitutes, such as GERANIUM 230/3 MOD; GERANIUM ABQ5629; GERANIUM BOURBON DQ (AC) XN 41563TT; GERANODYLE; GERANYL ACETATE; GERANYL BUTYRATE; HEDIONE; HEDIONE HC; HEXENYL-3-CIS SALICYLATE; HEXYL CINNAMIC ALDEHYDE; HEXYL CINNAMIC ALDEHYDE DQ AC XI 41505TT; HEXYL SALICYLATE; HYDROXYCITRONELLAL; ISOBUTYL PHENYL ACETATE; ISOBUTYL SALICYLATE; JASMATONE; Jasmin oils, essences, extracts, replacers or substitutes, such as JASMIN ABSOLUTE DQ (AC) 41568TT; JASMIN ARGENT 2; JASMONE CIS; JASMONYL; JASMOPYRANE FORTE; LILIAL and lilial substitutes; LINALOOL; MEFROSOL; METHYL ANTHRANILATE; METHYL ANTHRANILATE EXTRA; METHYL BENZOATE; METHYL PHENYL ACETATE; Neroli oils, essences, extracts, replacers or substitutes, such as NEROLI ESSENTIAL BASE AB 7632; NEROLI PHASE ESS; NEROLINE CRYSTALS; NEROLIONE; Orange oils, essences, extracts, replacers or substitutes, such as ORANGE FLOWER TEC AB 2169E; ORANGER CRYSTALS; ORANGER FLEUR CREME 1103/20; PELARGOL; PEONILE; PETALIA; PHENYL ETHYL ACETATE; PHENYL ETHYL ALCOHOL; PHENYL ETHYL ISOVALERATE; PHENYL ETHYL SALICYLATE CRYSTALS; ROSACETOL; ROSALVA; Rose oils, essences, extracts, replacers or substitutes, such as ROSE BASE ABF0339A-K182572; ROSE TW 62/10/20; SUPER MUGUET; TERPINEOL PURE; TETRAHYDRO LINALOOL; VERDANTIOL; YARA YARA; Ylang oils, essences, extracts, replacers or substitutes, such as YLANG AB 0388A; YLANG ECO ESSENCE;
and at least one ingredient from at least four of the groups B1 through B6 and B8 through B20 in the amounts indicated:
B1) about 0.01 wt % to about 1.5 wt %, more particularly about 0.01 wt % to about 1.41 wt % based on the perfumery ingredients used in the perfume composition, of at least one aldehydic ingredient selected from the group consisting of: ALDEHYDE C 10 DECYLIC; ALDEHYDE C 11 UNDECYLENIC; ALDEHYDE C 110 UNDECYLIC; ALDEHYDE C 12 LAURIC; ALDEHYDE C 12 MNA PURE; ALDEHYDE C 8 OCTYLIC FOOD GRADE; ALDEHYDE C 9 ISONONYLIC; ALDEHYDE C 9 NONYLIC FOOD GRADE; ALDEHYDE C 90 NONENYLIC 1%/TEC; ALDEHYDE C12 (DODECANAL); ALDEHYDE ISO C 11; mandarine aldehydes, such as ALDEHYDE MANDARINE 10%/TEC; trans-4-decenal, such as DECENAL-4-TRANS, DECENAL-4-TRANS 10%/TEC; DIHYDROFARNESAL; dodecanal, such as DODECENAL 10%/TEC; MYRALDENE; and TANGERINOL;
B2) about 0.01 wt % to about 25 wt %, more particularly about 0.01 wt % to about 22.49 wt %, based on the perfumery ingredients used in the perfume composition, of at least one amber ingredient selected from the group consisting of: Amberketal, such as AMBERKETAL 1%/TEC; AMBERKETAL IPM; Ambermax, such as AMBERMAX 10%/TEC, AMBERMAX 50%/DOWANOL TPM; Ambrocenide, such as AMBROCENIDE 10%/DPG; AMBROFIX; AMBROFIX FLAKES; Belambre, such as BELAMBRE 50%/IPM; BOISAMBRENE FORTE; CEDRYL ACETATE LIQUID; CEDRYL METHYL ETHER; CETALOX; ISO E SUPER; KARANAL; KEPHALIS; TIMBEROL; TRIMOFIX O;
B3) about 0.01 wt % to about 1.5 wt %, more particularly about 0.01 wt % to about 1.41 wt % based on the perfumery ingredients used in the perfume composition, of at least one animalic/leather ingredient selected from the group consisting of: ANIMALIS 1745 SUBST. PMF 2; cade oils, essences, extracts, replacers substitutes, such as CADE OIL SPAIN; GUAIACOL; INDOFLOR; Indole, such as INDOLE, INDOLE 1%/TEC; Indolene, such as INDOLENE 50%/CASTOR OIL; Suederal ingredients, such as SUEDERAL LT 0710;
B4) about 0.01 wt % to about 0.2 wt %, more particularly about 0.01 wt % to about 0.16 wt % based on the perfumery ingredients used in the perfume composition, of at least one anisic ingredient selected from the group consisting of: ANETHOLE; ANISE STAR OIL; ANISIC ALDEHYDE; ANISYL ACETATE; DIHYDRO ANETHOLE; ESTRAGOLE; fennel sweet oils, essences, extracts, bases, replacers or substitutes, such as FENNEL SWEET 50% DQ (AC) 24190TT; FENNEL SWEET DQ (AC) N 41632TT; FENNEL OIL SWEET; FENNEL OIL SWEET TECH;
B5) about 0.01 wt % to about 0.2 wt %, more particularly about 0.01 wt % to about 0.13 wt % based on the perfumery ingredients used in the perfume composition, of at least one balsamic ingredient selected from the group consisting of: Benzoin oils, essences, extracts, replacers or substitutes, such as BENZOIN SI GU ETA 50% BB AAF0515 41235EH; BENZYL ALCOHOL; BENZYL CINNAMATE; Olibanum oils, essences, extracts, replacers or substitutes, such as OLIBANUM COEUR DEP FREE 50%/TEC; OLIBANUM OIL SOMALIA ORPUR; PHENYL ETHYL PHENYL ACETATE;
B6) about 0.01 wt % to about 10 wt %, more particularly about 0.01 wt % to about 8.13 wt % based on the perfumery ingredients used in the perfume composition, of at least one camphoraceous/aromatic ingredient selected from the group consisting of: Armoise oils, essences, extracts, replacers or substitutes, such as ARMOISE OIL MOROCCO ORPUR COSMOS; Camphor and Camphor oils, essences, extracts, replacers or substitutes such as CAMPHOR; CAMPHOR OIL WHITE; Eucalyptol and Eucalyptol oils, essences, extracts, replacers or substitutes, such as EUCALYPTOL; EUCALYPTUS GLOBULUS OIL CHINA COSMOS; Lavandin oils, essences, extracts, replacers or substitutes, such as LAVANDIN BRIALIS DQ (AC) XN 41665TT; LAVANDIN GROSSO OIL FRANCE ORPUR; LAVANDIN RGV 4; Lavender oils, extracts, essences, replacers or substitutes, such as LAVENDER DQ (AC) XN 41569TT; Rosemary oils, essences, extracts, replacers or substitutes, such as ROSEMARY OIL; ROSEMARY OIL RECONST; Thuja oils, essences, extracts, replacers or substitutes, such as THUJA OIL KOREA;
B8) about 0.01 wt % to about 22 wt %, more particularly about 0.01 wt % to about 21.08 wt % based on the perfumery ingredients used in the perfume composition, of at least one fruity ingredient selected from the group consisting of: ACETATE C 6 HEXYLIC; AGRUMEX; ALLYL AMYL GLYCOLATE; ALLYL CAPROATE; ALLYL CYCLOHEXYL PROPIONATE; ALLYL OENANTHATE; AMYL BUTYRATE; APHERMATE; Apple oils, essences, extracts, replacers or substitutes, such as APPLE BASE ABF1016-K108004; Banana oils, essences, extracts, replacers or substitutes, such as BANANA BASE ABF0961A-K108784; BENZYL BUTYRATE; BENZYL ISOBUTYRATE; BENZYL PROPIONATE; BUTYL ACETATE; BUTYRIC ACID; Cassis oils, essences, extracts, replacers or substitutes, such as CASSIS BASE 345-F CS/4/20; CASSIS BASE 345B RECO TEC AB 8408D; COGNAC WHITE OIL EXTRA DQ (AC) 41547TT; CYCLOGALBANATE; DAMASCENONE; DAMASCONE ALPHA; DAMASCONE BETA; DAMASCONE DELTA; DECALACTONE DELTA; DECALACTONE GAMMA; Dewfruit oils, essences, extracts, replacers or substitutes, such as DEWFRUIT/2; DEWFRUIT TEC AB 2927R LILIAL FREE; DIETHYL MALONATE; DIMETHYL BENZYL CARBINYL ACETATE; DIMETHYL BENZYL CARBINYL BUTYRATE; DODECALACTONE DELTA; DODECALACTONE GAMMA; ETHYL ACETOACETATE; ETHYL BUTYRATE; ETHYL CAPROATE; ETHYL CAPRYLATE; ETHYL ISOAMYL KETONE; ETHYL ISOBUTYRATE; ETHYL METHYL-2-BUTYRATE; ETHYL OENANTHATE; ETHYL PELARGONATE; ETHYL PROPIONATE; ETHYL SAFRANATE; FLOROCYCLENE; FRAISTONE; FRUCTONE; FRUITATE; GARDOCYCLENE; GIVESCONE; Guave oils, essences, extracts, replacers or substitutes, such as GUAVE DUPLICATION/2; HEXENYL-3-CIS BUTYRATE; HEXENYL-3-CIS ISOBUTYRATE; HEXYL BUTYRATE; HEXYL ISOBUTYRATE; ISOAMYL ACETATE EXTRA; ISOAMYL BUTYRATE FR; JASMACYCLENE; MANZANATE; Melon oils, essences, extracts, replacers or substitutes, such as MELON HONEYDEW/2; METHOXY PHENYL BUTANONE; METHYL HEPTENONE PURE; METHYL HEXYL KETONE; METHYL-2-PENTENOIC ACID; 2-NECTARYL; OCTALACTONE GAMMA; PEACH PURE; PHENOXY ETHYL ISOBUTYRATE; PHENYL ETHYL ISOBUTYRATE; PRUNOLIDE; RASPBERRY KETONE (N112); STRAWBERRY PURE;
B9) about 0.001 wt % to about 0.01 wt %, more particularly about 0.001 wt % to about 0.002 wt % based on the perfumery ingredients used in the perfume composition, of at least one fungal ingredient selected from the group consisting of: AMYL VINYL CARBINOL; OCIMENE
B10) about 0.01 wt % to about 1 wt %, more particularly about 0.01 wt % to about 0.86 wt % based on the perfumery ingredients used in the perfume composition, of at least one gourmand ingredient selected from the group consisting of: ACETOIN; Acetyl pyrazine, such as ACETYL PYRAZINE 1%/TEC; BENZALDEHYDE; BUTYL BUTYRO LACTATE; Chocolate oils, essences, extracts, replacers or substitutes, such as CHOCOLAT NOIR 1130 TEC/3; CORYLONE DRIED; CYCLOTENE; Ethyl maltol, such as ETHYL MALTOL; ETHYL MALTOL 1%/BA; Homofuronol, such as HOMOFURONOL 20%/TEC; Hydroxy ethyl methyl thiazol, such as HYDROXY ETHYL METHYL THIAZOL 10%/TEC; ISOBUTAVAN; MALTYL ISOBUTYRATE;
B11) about 0.01 wt % to about 5 wt %, more particularly 0.041 wt % to about 4.28 wt % based on the perfumery ingredients used in the perfume composition, of at least one green ingredient selected from the group consisting of: ACETAL E; ALCOHOL C 6 HEXYLIC; ALDEHYDE C 6 HEXYLIC FOOD GRADE; BUTYL QUINOLINE SECONDARY; CYCLAL C; DIPHENYL OXIDE; ELINTAAL; ETHYL DECADIENOATE; ETHYL DIMETHYL Pyrazine, such as PYRAZINE 1%/TEC; Galbanone, such as GALBANONE 10; GALBANONE PURE; GARDENOL; Hexenal-2-trans, such as HEXENAL-2-TRANS 10%/TEC; HEXENOL-2-TRANS; HEXENOL-3-CIS; HEXENYL-3-CIS ACETATE; HEXENYL-3-CIS BENZOATE; HEXENYL-3-CIS PROPIONATE; ISOCYCLOCITRAL; Isohexylmethoxy pyrazine, such as ISOHEXYLMETHOXY PYRAZINE 1%/TEC; LIFFAROME; LIGANTRAAL; MACEAL; METHYL OCTYNE CARBONATE; NEOFOLIONE; Nonadienal, such as NONADIENAL; NONADIENAL 1%/TEC; NONADIENOL-2,6; Nonenal-6-cis, such NONENAL-6-CIS 10%/TEC; NONENOL-6-CIS; Petitgrain oils, essences, extracts, replacers or substitutes, such as PETITGRAIN ECO ESSENCE; PETITGRAIN OIL PARAGUAY; Phenoxyacetaldehyde, such as PHENOXY ACETALDEHYDE 50; Phenyl acetaldehyde, such as PHENYL ACETALDEHYDE 50%/PHENYL ETHYL ALC; PYRALONE; RESEDAL; ROSE OXIDE; ROSYRANE SUPER; STEMONE; TRICYCLAL; TRIFERNAL; UNDECATRIENE; UNDECAVERTOL; Violet nitrile, such as VIOLET NITRILE 0.1%/TEC; VIOLET NITRILE 10%/TEC; VIRIDINE;
B12) about 0.01 wt % to about 0.5 wt %, more particularly 0.01 wt % to about 0.1 wt % based on the perfumery ingredients used in the perfume composition, of at least one herbal ingredient selected from the group consisting of: Basil oils, essences, extracts, replacers or substitutes, such as BASIL OIL EGYPT ORPUR; Camomile oils, essences, extracts, replacers or substitutes, such as CAMOMILE ENGLISH DQ (AC) XN 41528TT; CITRONELLAL; Clary sage oils, essences, extracts, replacers or substitutes, such as CLARY SAGE OIL COSMOS; CLARY SAGE OIL FRANCE ORPUR; CYPRISATE; Eucalyptus oils, extracts, essences, replacers or substitutes, such as EUCALYPTUS CITRIODORA OIL BRAZIL; HERBOXANE; PINOACETALDEHYDE; TANAISONE; Thyme oils, essences, extracts, replacers or substitutes, such as THYME OIL RED 40-45%; THYME WHITE DQ (AC) XN 41491TT; THYMOL CRYSTALS;
B13) about 0.01 wt % to about 5 wt %, more particularly about 0.01 wt % to about 4.3 wt % based on the perfumery ingredients used in the perfume composition, of at least one marine/watery ingredient selected from the group consisting of: ADOXAL; Azurone, such as AZURONE 10%/TEC; CALONE 1951; FENNALDEHYDE; FLORALOZONE; FLORHYDRAL; MELONAL; SCENTENAL; TROPIONAL; VERNALDEHYDE;
B14) about 0.01 wt % to about 0.5 wt %, more particularly about 0.01 wt % to about 0.47 wt % based on the perfumery ingredients used in the perfume composition, of at least one mint ingredient selected from the group consisting of: Buchu leaf oils, essences, extracts, replacers or substitutes, such as BUCHU LEAF OIL SOUTH AFRICA COSMOS; CARVONE LAEVO; Cornmint oils, essences, extracts, replacers or substitutes, such as CORNMINT OIL DEMENTHOLIZED; FRESKOMENTHE; ISOMENTHONE DL; MENTHOL LAEVO; MENTHOL-DL; MENTHONE; MENTHYL ACETATE; Peppermint oils, essences, extracts, replacers or substitutes, such as PEPPERMINT AM FAR WEST DQ AC 41624TT; PEPPERMINT AM MID WEST MIW DQ AC 41253TT; PEPPERMINT AM WILL REDIST DQ AC 24150TT; PEPPERMINT AM WILLAM NAT DQ AC 37968TT; PEPPERMINT AMER 9303 DQ (AC) 37934TT; PEPPERMINT CHINESE T'LES(EXCN)DQ 24329TT; PEPPERMINT CHINESE TR (CN) DQ 24109TT; PEPPERMINT CN TERPLESS FDC DQ AC 37921TT; PEPPERMINT HMF DQ 24817TT; PEPPERMINT INDIAN TPC-1 DQ AC 24049TT; PEPPERMINT OIL BLEND; PEPPERMINT PIP IND REC.FDC DQ AC 24040TT; Spearmint oils, essences, extracts, replacers or substitutes, such as SPEARMINT AM FW NAT DQ AC XN 41610TT; SPEARMINT OIL USA TYPE;
B15) about 0.01 wt % to about 50 wt %, more particularly about 0.01 wt % to about 44.43 wt % based on the perfumery ingredients used in the perfume composition, of at least one musk ingredient selected from the group consisting of: AMBRETTOLIDE; CASHMERAN; COSMONE; Cyclopentadecanolide, such as CYCLO PENTA DECANOLIDE DQ 1% PG; ETHYLENE BRASSYLATE; GALAXOLIDE; GALAXOLIDE S; HABANOLIDE; MUSCENONE; MUSK C14; SERENOLIDE; SILVANONE SUPRA; SYLKOLIDE; VELVIONE;
B16) about 0.01 wt % to about 10 wt % based on the perfumery ingredients used in the perfume composition, of at least one orris ingredient selected from the group consisting of: CETONE V; DIHYDRO IONONE BETA; IONONE BETA; IRISONE ALPHA; IRISONE PURE; ISORALDEINE 70; ISORALDEINE 95; ORIVONE;
B17) about 0.01 wt % to about 1 wt %, more particularly about 0.01 wt % to about 0.45 wt % based on the perfumery ingredients used in the perfume composition, of at least one spicy ingredient selected from the group consisting of: Cardamom oils, essences, extracts, replacers or substitutes, such as CARDAMOM SEED OIL ORPUR; CARDAMOM SUBSTITUTE 1527 F; CARDAMOME SUBSTITUT 1527 F/2; CARYOPHYLLENE; CINNAMIC ALCOHOL CINNAMIC ALCOHOL; CINNAMIC ALDEHYDE; Cinnamon leaf oils, essences, extracts, replacers or substitutes, such as CINNAMON LEAF OIL WASHED ORPUR; Clove oils, essences, extracts, replacers or substitutes, such as CLOVE BUD OIL; CLOVE LEAF OIL COLORLESS; CLOVE LEAF OIL RECTIFIED RB COSMOS; Coriander oils, essences, extracts, replacers or substitutes, such as CORIANDER SEEDS OIL ORPUR COSMOS; Elemi oils, essences, extracts, replacers or substitutes, such as ELEMI RESINOID 50%/BB; ETHYL CINNAMATE; EUGENOL; Ginger oils, essences, extracts, replacers or substitutes, such as GINGER OIL INDIA ORPUR; GINGER ROOT FRESH CUT; ISOEUGENOL; IMETHYL CINNAMATE; METHYL ISOEUGENOL; MYSTIKAL; Nutmeg oils, essences, extracts, replacers or substitutes, such as NUTMEG OIL INDONESIA; Pepper oils, essences, extracts, replacers or substitutes, such as PEPPER BLACK OIL MADAGASCAR ORPUR; SZECHUAN PEPPER (ASH BARK) DQ AF 240701T;
B18) about 0.01 wt % to about 0.5 wt %, more particularly about 0.01 wt % to about 0.21 wt % based on the perfumery ingredients used in the perfume composition, of at least one sulphurous ingredient selected from the group consisting of: Anjeruk, such as ANJERUK 0.01%/TEC; Corps cassis, such as CORPS CASSIS 0.1%/TEC; CORPS CASSIS 10%/TEC; Corps pamplemousse, such as CORPS PAMPLEMOUSSE PURE 1%/TEC; CORPS PAMPLEMOUSSE PURE 10%/TEC; Dimethyl sulphide, such as DIMETHYL SULFIDE; DIMETHYL SULFIDE 1%/TEC; GARDAMIDE; Labienoxime, such as LABIENOXIME 1%/IPM-TEC; Mercaptans, such as MERCAPTO-8 MENTHENE-1 PARA 0.1% IN TEC; METHYL ISOPROPYL THIAZOLE; Nardozeste oils, essences, extracts, replacers or substitutes, such as NARDOZESTE ABQ5031; NEOCASPIRENE EXTRA; NONIVAMIDE 1% TRIACETIN; Oxane, such as OXANE 50%/TEC; PARADISAMIDE; Paramenthone, such as PARAMENTHONE 1%/TEC;
B19) about 0.01 wt % to about 10 wt %, more particularly about 0.2 wt % to about 7.83 wt % based on the perfumery ingredients used in the perfume composition, of at least one sweet/powdery ingredient selected from the group consisting of: ACETOPHENONE; AUBEPINE PARA CRESOL; BICYCLO NONALACTONE; COUMARIN; Ethyl laitone, such as ETHYL LAITONE 1%/TEC; ETHYL VANILLIN; HELIOTROPIN Vanilla oils, essences, extracts, replacers or substitutes, such as VANILLA ABSOLUTE 20 FOLD DQ AC 41493TT; VANILLA S/ABS DEC 50% PG AAF0517 L228655; VANILLA SUP ABS DEC DQ P17 SB AC 41561TT; VANILLAL DQ (AF) 41319TT; VANILLIN; VANILLIN DQ (AF) 41320TT; Vanolia oils, essences, extracts, replacers or substitutes, such as VANOLIA BASE ABF0303B; VERATRIC ALDEHYDE;
B20) about 0.01 wt % to about 15 wt %, more particularly about 0.01 wt % to about 10.37 wt % based on the perfumery ingredients used in the perfume composition, of at least one woody/pine ingredient selected from the group consisting of: BORNEOL; BORNYL ACETATE LIQUID; BUTYL CYCLOHEXANOL PARA; BUTYL CYCLOHEXYL ACETATE PARA; Cedar wood oils, essences, extracts, replacers or substitutes, such as CEDARWOOD OIL USA VIRGINIA TYPE ORPUR; CONIFERAN; EBANOL; EVERNYL; FENCHYL ACETATE; Guaiac wood oils, essences, extracts, replacers or substitutes, such as GUAIACWOOD OIL PARAGUAY; ISONONANYL ACETATE; JAVANOL; KOHINOOL; MENTHANYL ACETATE; METHYL CEDRYL KETONE; NOPYL ACETATE; OSYROL; OXYOCTALINE FORMATE; Patchouli oils, essences, extracts, replacers or substitutes, such as PATCHOULI OIL COLORLESS INDONESIA; PATCHOULI OIL IRONFREE INDONESIA COSMOS; PINENE ALPHA; PINENE BETA; RADJANOL; RADJANOL SUPER; Turpentine oils, essences, extracts, replacers or substitutes, such as TURPENTINE OIL RECTIFIED; VERTOFIX COEUR; Vetiver oils, essences, extracts, replacers or substitutes, such as VETIVER OIL HAITI ORPUR ORGANIC COSMOS;
and optionally
B21) about 0.01 wt % to about 10 wt % based on the perfumery ingredients used in the perfume composition, of at least one ingredient selected from the group consisting of: ALDEHYDE C12 (DODECANAL); and MENTHYL ACETATE.

23. The perfume composition of claim 21, comprising 0.042% of at least one aldehydic ingredient, 10.938% of at least one citrus ingredient, 4.271% of at least one green ingredient, 3.396% of at least one marine/watery ingredient, 0.208% of at least one sulphurous ingredient, 63.542% of at least one floral ingredient, 2.083% of at least one orris ingredient, 12.604% of at least one fruity ingredient, 2.083% of at least one amber ingredient, 0.042% of at least one animalic/leather ingredient, 0.271% of at least one sweet/powdery ingredient, and 0.521% of at least one woody/pine ingredient.

24. The perfume composition of claim 21, comprising 0.221% of at least one aldehydic ingredient, 1.905% of at least one citrus ingredient, 3.087% of at least one green ingredient, 2.346% of at least one marine/watery ingredient, 0.060% of at least one sulphurous ingredient, 59.944% of at least one floral ingredient, 10.024% of at least one orris ingredient, 21.071% of at least one fruity ingredient, 0.441% of at least one spicy ingredient, 0.200% of at least one gourmand ingredient, 0.200% of at least one sweet/powdery ingredient, and 0.501% of at least one woody/pine ingredient.
